(19) United States
(12) Patent Application Publication
(10) Pub. No.: US 2025/0317946 A1
(43) Pub. Date: Oct. 9, 2025

(54) CAPACITY ENHANCEMENT FOR INTERLACED SIDELINK FEEDBACK TRANSMISSIONS

(71) Applicant: QUALCOMM INCORPORATED, San Diego, CA (US)

(72) Inventors: Siyi Chen, Beijing (CN); Jing Sun, San Diego, CA (US); Chih-Hao Liu, San Diego, CA (US); Xiaoxia Zhang, San Diego, CA (US); Changlong Xu, Beijing (CN); Shaozhen Guo, Beijing (CN); Luanxia Yang, Beijing (CN); Hao Xu, Beijing (CN)

(21) Appl. No.: 18/881,648

(22) PCT Filed: Aug. 10, 2022
(86) PCT No.: PCT/CN2022/111343

§ 371 Date: Jan. 6, 2025

(51) Int. Cl. H04W 72/25; H04J 13/00; H04W 72/0446; H04W 72/0453; H04W 92/18

(52) U.S. Cl. CPC H04W 72/25; H04J 13/004; H04W 72/0446; H04W 72/0453; H04W 92/18

(57) ABSTRACT

Methods, systems, and devices for wireless communications are described. In some examples, a first user equipment (UE) may receive, from a second UE, sidelink signaling via a set of resources of a sidelink channel and generate a set of interlaced feedback data symbols for transmission in a sidelink feedback channel in accordance with an interlacing configuration. The interlacing configuration may indicate that the sidelink feedback channel includes at least a first symbol period and a second symbol period. Upon generating the set of interlaced feedback data symbols, the first UE may transmit, to the second UE via the first symbol period and the second symbol period, a feedback transmission that is based on the set of interlaced feedback data symbols.

### CROSS REFERENCE

The present Application is a 371 national stage filing of International PCT Application No. PCT/CN2022/111343 by Chen et al. entitled “CAPACITY ENHANCEMENT FOR INTERLACED SIDELINK FEEDBACK TRANSMISSIONS,” filed Aug. 10, 2022, which is assigned to the assignee hereof, and which is expressly incorporated by reference in its entirety herein.

### FIELD OF TECHNOLOGY

The present disclosure relates to wireless communications, including capacity enhancement for interlaced sidelink feedback transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support sidelink communications between one or more wireless devices (e.g., UEs). In some examples, UEs communicating via sidelink may select resources from resources included in a sidelink feedback channel (e.g., physical sidelink feedback channel (PSFCH)) and utilize the selected resource to receive feedback messages responsive of previously received sidelink messages.

### SUMMARY

The described techniques relate to improved methods, systems, devices, and apparatuses that support capacity enhancement for interlaced sidelink feedback transmissions. For example, the described techniques provide for increased user equipment (UE) multiplexing in an interlaced sidelink feedback channel. In some examples, a first UE may receive, from a second UE, sidelink signaling via a set of resources of a sidelink channel. Upon receiving the sidelink signaling, the first UE may generate a set of interlaced feedback data symbols for transmission in a sidelink feedback channel. In some examples, the first UE may generate the set of interlaced feedback data symbols using an interlacing configuration. The interlacing configuration may indicate that the sidelink feedback channel includes two or more consecutive symbol periods. For example, the interlacing configuration may indicate that the sidelink feedback channel includes a first symbol period and a second symbol period. The first UE may then transmit, during the first symbol period and the second symbol period, a feedback transmission that is based the set of interlaced feedback data symbols.

Additionally or alternatively, an additional sidelink feedback channel may be added to a slot subsequent to a slot including the sidelink feedback in an effort to increase the amount of feedback resources. Additionally or alternatively, the sequence length associated with the interlaced feedback data symbols may be increased to a length that exceeds a number of resource elements (REs) in a physical resource block (PRB). Using the method as described herein may increase the channel bandwidth occupancy and UE multiplexing capacity of the sidelink feedback channel when compared to other methods.

A method for wireless communications at a first UE is described. The method may include receiving, from a second UE, sidelink signaling via a set of resources of a sidelink channel, generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel, and transmitting, to the second UE within the frequency range via the first symbol period and the second symbol period, a feedback transmission based on the set of multiple interlaced feedback data symbols.

An apparatus for wireless communications at a first UE is described. The apparatus may include a processor, memory coupled with the processor, and instructions stored in the memory. The instructions may be executable by the processor to cause the apparatus to receive, from a second UE, sidelink signaling via a set of resources of a sidelink channel, generate, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel, and transmit, to the second UE within the frequency range via the first symbol period and the second symbol period, a feedback transmission based on the set of multiple interlaced feedback data symbols.

Another apparatus for wireless communications at a first UE is described. The apparatus may include means for receiving, from a second UE, sidelink signaling via a set of resources of a sidelink channel, means for generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel, and means for transmitting, to the second UE within the frequency range via the first symbol period and the second symbol period, a feedback transmission based on the set of multiple interlaced feedback data symbols.

A non-transitory computer-readable medium storing code for wireless communications at a first UE is described. The code may include instructions executable by a processor to receive, from a second UE, sidelink signaling via a set of resources of a sidelink channel, generate, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel, and transmit, to the second UE within the frequency range via the first symbol period and the second symbol period, a feedback transmission based on the set of multiple interlaced feedback data symbols.

Some examples of the method, apparatuses, and non-transitory computer-readable medium described herein may further include operations, features, means, or instructions for generating the feedback transmission based on applying an orthogonal cover code (OCC) to the set of multiple interlaced feedback data symbols across the first symbol period and the second symbol period in accordance with the interlacing configuration.

In some examples of the method, apparatuses, and non-transitory computer-readable medium described herein, the OCC includes a TD-OCC or a FD-OCC.

Some examples of the method, apparatuses, and non-transitory computer-readable medium described herein may further include operations, features, means, or instructions for receiving control signaling indicating an OCC of a set of multiple OCCs, the OCC assigned to the first UE.

Some examples of the method, apparatuses, and non-transitory computer-readable medium described herein may further include operations, features, means, or instructions for generating the set of multiple interlaced feedback data symbols based on an interlace sequence indicated in the interlacing configuration.

In some examples of the method, apparatuses, and non-transitory computer-readable medium described herein, transmitting the feedback transmission may include operations, features, means, or instructions for transmitting, in accordance with the interlacing configuration, the set of multiple interlaced feedback data symbols during the first symbol period and a repetition of the set of multiple interlaced feedback data symbols during the second symbol period.

Some examples of the method, apparatuses, and non-transitory computer-readable medium described herein may further include operations, features, means, or instructions for applying a TD-OCC to the set of multiple interlaced feedback data symbols during the first symbol period and the repetition of the set of multiple interlaced feedback data symbols during the second symbol period.

In some examples of the method, apparatuses, and non-transitory computer-readable medium described herein, transmitting the feedback transmission may include operations, features, means, or instructions for transmitting, in accordance with the interlacing configuration, a first portion of the set of multiple interlaced feedback data symbols and a repetition of the first portion during the first symbol period, and a second portion of the set of multiple interlaced feedback data symbols and a repetition of the second portion during the second symbol period.

Some examples of the method, apparatuses, and non-transitory computer-readable medium described herein may further include operations, features, means, or instructions for applying a FD-OCC to the first portion of the set of multiple interlaced feedback data symbols and the repetition of the first portion during the first symbol period, and the second portion of the set of multiple interlaced feedback data symbols and the repetition of the second portion during the second symbol period.

In some examples of the method, apparatuses, and non-transitory computer-readable medium described herein, the set of multiple interlaced feedback data symbols may be arranged according to a comb structure.

In some examples of the method, apparatuses, and non-transitory computer-readable medium described herein, the set of multiple interlaced feedback data symbols may be arranged according to a frequency domain multiplexing (FDM) scheme.

In some examples of the method, apparatuses, and non-transitory computer-readable medium described herein, transmitting the feedback transmission may include operations, features, means, or instructions for transmitting, in accordance with the interlacing configuration, a first portion of the set of multiple interlaced feedback data symbols during the first symbol period and a second portion of the set of multiple interlaced feedback data symbols during the second symbol period.

In some examples of the method, apparatuses, and non-transitory computer-readable medium described herein, transmitting the feedback transmission may include operations, features, means, or instructions for transmitting, in accordance with the interlacing configuration, the set of multiple interlaced feedback data symbols within a portion of the frequency range during the first symbol period and the second symbol period.

Some examples of the method, apparatuses, and non-transitory computer-readable medium described herein may further include operations, features, means, or instructions for receiving control signaling indicating the interlacing configuration.

In some examples of the method, apparatuses, and non-transitory computer-readable medium described herein, the set of consecutive symbol periods includes two consecutive symbol periods or four consecutive symbol periods.

A method for wireless communication at a first UE is described. The method may include receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group, receiving a sidelink transmission via a first set of sidelink resources of a slot of the subset of slots, and transmitting a feedback transmission associated with the sidelink transmission via a first feedback resource of the feedback channel group or a second feedback resource of the feedback channel group.

An apparatus for wireless communication at a first UE is described. The apparatus may include a processor, memory coupled with the processor, and instructions stored in the memory. The instructions may be executable by the processor to cause the apparatus to receive control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group, receive a sidelink transmission via a first set of sidelink resources of a slot of the subset of slots, and transmit a feedback transmission associated with the sidelink transmission via a first feedback resource of the feedback channel group or a second feedback resource of the feedback channel group.

Another apparatus for wireless communication at a first UE is described. The apparatus may include means for receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group, means for receiving a sidelink transmission via a first set of sidelink resources of a slot of the subset of slots, and means for transmitting a feedback transmission associated with the sidelink transmission via a first feedback resource of the feedback channel group or a second feedback resource of the feedback channel group.

A non-transitory computer-readable medium storing code for wireless communication at a first UE is described. The code may include instructions executable by a processor to receive control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group, receive a sidelink transmission via a first set of sidelink resources of a slot of the subset of slots, and transmit a feedback transmission associated with the sidelink transmission via a first feedback resource of the feedback channel group or a second feedback resource of the feedback channel group.

In some examples of the method, apparatuses, and non-transitory computer-readable medium described herein, the control signaling includes a parameter that indicates a defined number of slots between a slot including a set of sidelink resources and the slot including the first feedback resource.

In some examples of the method, apparatuses, and non-transitory computer-readable medium described herein, the first feedback resource occurs before the second feedback resource in time.

In some examples of the method, apparatuses, and non-transitory computer-readable medium described herein, the first feedback resource includes a reference physical sidelink feedback channel (PSFCH) and the second feedback resource includes an additional PSFCH.

Some examples of the method, apparatuses, and non-transitory computer-readable medium described herein may further include operations, features, means, or instructions for receiving second control signaling indicating the feedback channel group.

Some examples of the method, apparatuses, and non-transitory computer-readable medium described herein may further include operations, features, means, or instructions for receiving second control signaling activating a set of feedback resources of the feedback channel group.

A method for wireless communication at a first UE is described. The method may include receiving control signaling indicating a set of sidelink resources including a set of slots within a sidelink channel, a subset of the set of slots including a first set of symbols allocated for a physical sidelink shared channel (PSSCH) and a second set of symbols after the first set of symbols allocated for a PSFCH, where the PSFCH includes a set of multiple resource blocks (RBs) within a symbol period, receiving, from a second UE, a sidelink transmission via a set of resources of the first set of symbols, and transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

An apparatus for wireless communication at a first UE is described. The apparatus may include a processor, memory coupled with the processor, and instructions stored in the memory. The instructions may be executable by the processor to cause the apparatus to receive control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period, receive, from a second UE, a sidelink transmission via a set of resources of the first set of symbols, and transmit, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

Another apparatus for wireless communication at a first UE is described. The apparatus may include means for receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period, means for receiving, from a second UE, a sidelink transmission via a set of resources of the first set of symbols, and means for transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

A non-transitory computer-readable medium storing code for wireless communication at a first UE is described. The code may include instructions executable by a processor to receive control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period, receive, from a second UE, a sidelink transmission via a set of resources of the first set of symbols, and transmit, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

In some examples of the method, apparatuses, and non-transitory computer-readable medium described herein, the sequence length corresponds to a number of resources elements in two or more RBs of the set of multiple RBs.

Some examples of the method, apparatuses, and non-transitory computer-readable medium described herein may further include operations, features, means, or instructions for receiving second control signaling indicating the sequence length of the interlace sequence.

Some examples of the method, apparatuses, and non-transitory computer-readable medium described herein may further include operations, features, means, or instructions for updating the sequence length of the interlace sequence based on an environment characteristic associated with the first UE.

Some examples of the method, apparatuses, and non-transitory computer-readable medium described herein may further include operations, features, means, or instructions for determining a resource pool for the PSSCH based on the sequence length.

### BRIEF DESCRIPTION OF THE DRAWINGS

FIGS. 1 and 2 illustrate examples of a wireless communications system that supports capacity enhancement for interlaced sidelink feedback transmissions in accordance with one or more aspects of the present disclosure.

FIGS. 3A, 3B, 3C, 3D, and 3E illustrate examples of an interlace mapping schemes that supports capacity enhancement for interlaced sidelink feedback transmissions in accordance with one or more aspects of the present disclosure.

FIG. 4 illustrates an example of a PSFCH slot layout that supports capacity enhancement for interlaced sidelink feedback transmissions in accordance with one or more aspects of the present disclosure.

FIG. 5 illustrates an example of an interlaced PSFCH that supports capacity enhancement for interlaced sidelink feedback transmissions in accordance with one or more aspects of the present disclosure.

FIG. 6 illustrates an example of a process flow that supports capacity enhancement for interlaced sidelink feedback transmissions in accordance with one or more aspects of the present disclosure.

FIGS. 7 and 8 show block diagrams of devices that support capacity enhancement for interlaced sidelink feedback transmissions in accordance with one or more aspects of the present disclosure.

FIG. 9 shows a block diagram of a communications manager that supports capacity enhancement for interlaced sidelink feedback transmissions in accordance with one or more aspects of the present disclosure.

FIG. 10 shows a diagram of a system including a device that supports capacity enhancement for interlaced sidelink feedback transmissions in accordance with one or more aspects of the present disclosure.

FIGS. 11 through 16 show flowcharts illustrating methods that support capacity enhancement for interlaced sidelink feedback transmissions in accordance with one or more aspects of the present disclosure.

### DETAILED DESCRIPTION

In some examples, a wireless communications system may support sidelink communication or communication between two or more user equipment (UEs). As one example of sidelink communication, a first UE may transmit a sidelink signal to a second UE. Moreover, the second UE may transmit feedback to the first UE regarding the sidelink signal. Feedback may be transmitted via resources of a physical sidelink feedback channel (PSFCH). In some examples, the PSFCH may occupy one symbol period in a sidelink slot. In one example, resources of the PSFCH may be divided into sets of resources based on a number of subchannels and a number of slots of a physical sidelink shared channel (PSSCH) associated with the PSFCH. The second UE may determine which set of resources to use based on an identifier (ID) of the transmitting UE (e.g., the first UE) and an identifier of the receiving UE (e.g., the second UE). However, such methods may result in a bandwidth occupancy that is below a threshold (e.g., less than 2 MHz). Alternatively, PSFCH may be extended using an interlaced waveform. In such example, each UE transmitting feedback may be assigned an interlace sequence of length 12 and transmit repetitions of the interlace sequence over a set of resource blocks (RBs) (e.g., 10 RBs). The UEs receiving the feedback may receive the interlaced waveform and determine the feedback using the interlace sequence. Such methods may increase the channel occupancy, but may decrease the number of UEs able to send feedback.

As described herein, the PSFCH may occupy two or more symbol periods in a sidelink slot and a UE may transmit feedback during two or more symbol periods using an interlaced waveform. In some examples, each UE transmitting feedback may be assigned an interlace sequence of a set of sequences. In one example, each UE may additionally be assigned an orthogonal cover code (OCC) of a set of OCCs. To generate feedback, a UE may map the interlace sequence to resource elements (REs) of the two or more symbol periods according to a mapping scheme and apply the assigned OCC to the REs. The UE may then transmit the feedback during the two or more symbol periods. In another example, to generate the feedback, the UE may map the interlace sequence to REs of the two or more symbol periods according to a comb structure or a frequency domain multiplexing scheme (FDM) and transmit the feedback during the two or more symbol periods. Additionally or alternatively, an additional PSFCH may be introduced in a slot subsequent to a PSFCH to add additional feedback resources. Additionally or alternatively, the sequence length of the interlace sequence may be increased (e.g., to a sequence length or 24). Using such methods may increase the number of UEs that can report feedback using an interlaced waveform.

Aspects of the disclosure are initially described in the context of wireless communications systems. Additional aspects are described in the contexts of interlace mapping schemes, a PSFCH slot layout, an interlaced PSFCH, and a process flow. Aspects of the disclosure are further illustrated by and described with reference to apparatus diagrams, system diagrams, and flowcharts that relate to capacity enhancement for interlaced sidelink feedback transmissions.

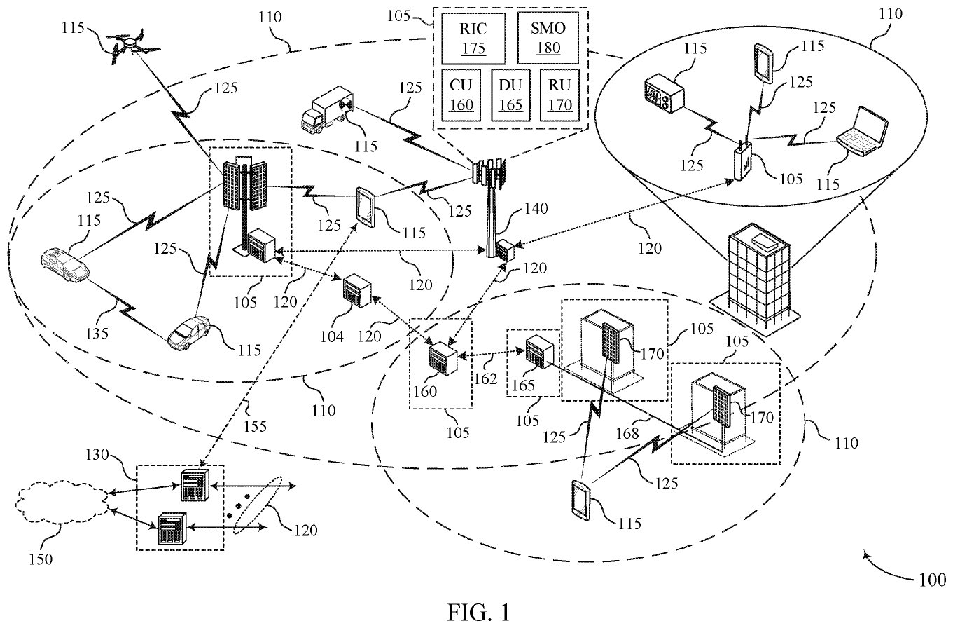

FIG. 1 illustrates an example of a wireless communications system 100 that supports capacity enhancement for interlaced sidelink feedback transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support capacity enhancement for interlaced sidelink feedback transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, an RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The methods as described herein may increase user equipment (UE) multiplexing in an interlaced sidelink feedback channel when compared to other methods. In some examples, a first UE 115 may receive, from a second UE 115, sidelink signaling via a set of resources of a sidelink channel. Upon receiving the sidelink signaling, the first UE 115 may generate a set of interlaced feedback data symbols for transmission via the sidelink feedback channel. In some examples, the first UE 115 may generate the set of interlaced feedback data symbols using an interlacing configuration. The interlacing configuration may indicate that the sidelink feedback channel includes two or more consecutive symbol periods. For example, the interlacing configuration may indicate that the sidelink feedback channel includes a first symbol period and a second symbol period. After generating the set of interlaced data symbols, the first UE may transmit, during the first symbol period and the second symbol period, a feedback transmission that is based on the set of interlaced feedback data symbols.

Additionally or alternatively, an additional sidelink feedback channel may be added to a slot subsequent to a slot including the sidelink feedback in an effort to increase the amount of feedback resources. Additionally or alternatively, the sequence length associated with the interlaced feedback data symbols may be increased to a length that exceeds a number of REs in a physical resource block (PRB). Using the method as described herein may increase the channel bandwidth occupancy and UE multiplexing capacity of the sidelink feedback channel when compared to other methods.

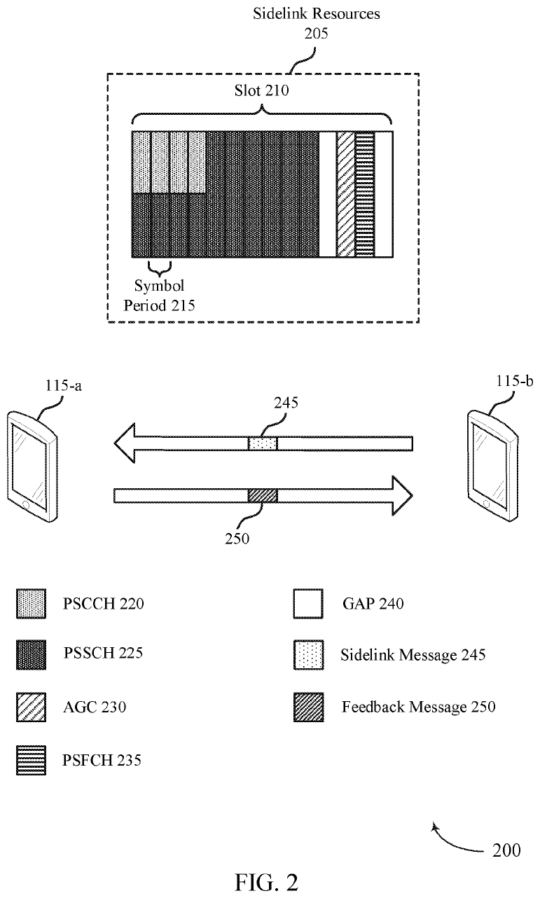

FIG. 2 illustrates an example of a wireless communications system 200 that supports capacity enhancement for interlaced sidelink feedback transmissions in accordance with one or more aspects of the present disclosure. In some examples, the wireless communications system 200 may implement aspects of a wireless communications system 100. For example, the wireless communications system 200 may include a UE 115-a and a UE 115-b which may be examples of UEs 115 as described with reference to FIG. 1.

In some examples, the wireless communications system 200 may support sidelink communication. Sidelink communication may be described as communication between two or more UEs 115. As one example of sidelink communication, the UE 115-b may transmit a sidelink message 245 to the UE 115-a. In order to communicate via sidelink communication, UEs 115 participating the sidelink communication may receive control signaling (e.g., from a network entity) indicating a set of sidelink resources 205. The set of sidelink resources 205 may include a set of slots 210 and each slot 210 may include multiple symbol periods 215 (e.g., 14 symbol periods). In some examples, a subset of the slots may include a symbol period allocated for a PSFCH 235. During the symbol period 215 allocated for PSFCH 235, the UE 115 may transmit a feedback message 250 (e.g., ACK or NACK) in response to receiving the sidelink message 245 (e.g., during a one or more previous symbol periods 215 allocated for a PSSCH 225). Slots 210 including the symbol period 215 allocated for PSFCH 235 may also include symbol periods 215 allocated for a physical sidelink control channel (PSCCH) 220, automatic gain control (AGC) 230, and a gap 240.

In some examples, the control signaling may include parameters which define aspects of the PSFCH 235. For example, the control signaling may include a parameter indicating a periodicity of the PSFCH 235 (e.g., periodPSFCHresource). The periodicity for PSFCH 235 may be 0 slots, 1 slot, 2 slots, or 4 slots. If the periodicity for the PSFCH 235 is 0 slots, there may be no PSFCH 235 (e.g., no slots 210 include symbol periods 215 allocated for the PSFCH 235). Additionally, the control signaling may include a parameter indicating a defined (e.g., minimum) number of slots 210 between the PSSCH 225 and the PSFCH 235 (e.g., MinTimeGapPSFCH). The transmission timing for PSFCH 235 may be the first slot with PSFCH 235 after the minimum number of slots 210.

Because multiple UEs 115 may be transmitting a feedback message 250 during the symbol period allocated for PSFCH 235. The UEs 115 may undergo one or more procedures to select resources from a set of feedback resources of the PSFCH 235. First, the UEs 115 may identify a total number of PRBs available for feedback transmission (e.g., M_{PRB,set}^{PSFCH}). The total number of PRBs may be divided by a number of sub-channels of the set of sidelink resources 205 (e.g., N_{subch}) and a number of slots corresponding to the PSFCH 235

$$( e . g . , {N}_{PSSCH}^{PSFCH} )$$

to determine a number of PRBs per subchannel/slot

$$( e . g . , {M}_{subch , slot}^{PSFCH} )$$

as shown in Equation 1.

$${M}_{subch , slot}^{PSFCH} = \frac{{M}_{PRB , set}^{PSFCH}}{{N}_{PSSCH}^{PSFCH} \times {N}_{subch}} \qquad ( 1 )$$

$${M}_{subch , slot}^{PSFCH}$$

PRBs among the available PRBs are associated with feedback of a transmission in a sub-channel of a slot. Further, the size of the resource pool for the PSFCH 235

$$( e . g . , {N}_{PRB , CS}^{PSFCH} )$$

may be determined by multiplying a number of PSFCH types

$$( e . g . , {N}_{type}^{PSFCH} ) ,$$

a number of cyclic shift pairs

$$( e . g . , {N}_{CS}^{PSFCH} ) ,$$

PRBs per subchannel and slot

$$( e . g . , {M}_{subch , slot}^{PSFCH} )$$

as shown in Equation 2. A pair of cyclic shifts (within a PRB) may be used to distinguish ACK from NACK and may be equal to 1, 2, 3, or 6. The PSFCH type may be equal to 1. In some examples, within the resource pool, the resources may be indexed from PRB index first and then in CS pair index.

$${R}_{PRB , CS}^{PSFCH} = {N}_{type}^{PSFCH} \times {N}_{CS}^{PSFCH} \times {M}_{subch , slot}^{PSFCH} \qquad ( 2 )$$

In the example of FIG. 2, the UE 115-b may transmit the sidelink message 245 to the UE 115-a via PSSCH resources that are located within a first subchannel and a first slot. The UE 115-a may receive the sidelink message 245 and determine a PSFCH resource to use to transmit the feedback message 250 (e.g., ACK/NACK for the sidelink message 245) to the UE 115-b. First, the UE 115-a may identity the

$${M}_{subch , slot}^{PSFCH}$$

PRBs for the first subchannel and the first slot, and additionally, identify the resource pool. The UE 115-a may then select a PSFCH resource from the resource pool using an ID of the UE 115-b (e.g., Layer 1 ID) and an ID of the UE 115-a (e.g., equal to 0 in unicast sidelink communication) and transmit the feedback message 250 via the selected PSFCH resource. For multicast, each UE (e.g., receiving the multicast transmission) may select a PSFCH resource from the resources pool and transmit the feedback message 250 (e.g., ACK/NACK) via the PSFCH resource. Using such methods to select a PSFCH resource may allow a UE 115 to transmit the feedback message 250 using a single PRB. Transmitting the feedback message 250 via a single PRB may result in a channel occupancy that is below the minimum threshold for channel occupancy (e.g., less than 2 MHZ).

In an effort to increase the channel occupancy, a PSFCH interlace may be introduced. In some examples, the PSFCH interlace may occupy a set of PRBs (e.g., 10 PRBs) in the single symbol period 215 of the PSFCH 235. Each UE 115 (e.g., each UE 115 configured for sidelink communication) may be assigned a respective interlace sequence of a set of interlace sequences. The set of interlace sequences may have sequence length of 12 (e.g., occupy a single PRB) and include mutually orthogonal sequences. In one example, the UE 115-a may be assigned a first interlace sequence and the UE 115-b may be assigned a second interlace sequence. After the UE 115-a receives or fails to receive the sidelink message 245 from the UE 115-b, the UE 115-a may transmit a feedback message 250 (e.g., ACK/NACK) to the UE 115-b. Transmitting the feedback message 250 may include transmitting repetitions of the interlace sequence (e.g., interlace sequence assigned to the UE 115-a) over the set of PRBs in the single symbol period of the PSFCH 235 with cyclic shift ramping (e.g., ten repetitions of the sequence over the ten PRBs). The UE 115-b may utilize the interlace sequence (e.g., the interlace sequence assigned to the UE 11-a) and the cyclic shift pair (e.g., assigned to the UE 115-a) to determine origin of the feedback message 250 and the contents of the feedback message 250 (e.g., ACK or NACK). However, using the interlaced PSFCH may not result in a good UE multiplexing capacity. For example, there may be a total of 5 interlace sequences in subcarrier spacing of 30 kHz and a total of 6 cyclic shift pairs. This may result in a multiplexing capacity of 30 UEs 115 which may be 10 times less than the number UEs 115 that may be multiplexed in a single RB for the above mentioned procedure.

In some examples, multiple UEs 115 may be multiplexed in the PSFCH 235 using simple time-domain multiplexing (TDM). In such example, the PSFCH 235 may span multiple symbol periods 215. The problem with PSFCH TDM among UEs 115 is that it may not be valid in an unlicensed band. For example, if a UE 115 does not transmit feedback during the first symbol period, there may be a gap between the AGC 230 and the PSFCH 235 (e.g., second symbol period of the PSFCH). As such, after performing the transmission during the symbol period 215 allocated for AGC 230, the UE 115 may lose channel occupancy time (COT) and may perform another listen-before-talk (LBT) procedure for transmitting the feedback which may be inefficient.

As described herein, a number of symbol periods 215 may be increased for an PSFCH interlace to increase PSFCH capacity. That is, more than one symbol period 215 may be allocated for the PSFCH 235 in a slot 210 and the more than one symbol period 215 may be contiguous to a second symbol period allocated for the gap 240. The number of symbol periods 215 for the PSFCH 235 may be pre-configured or RRC configured in a resource pool level. Each UE may occupy all PSFCH symbols of a same slot, and may use code division multiplexing, frequency division multiplexing, or both, to multiplex multiple UEs in the PSFCH for increasing PSFCH capacity. Moreover, UEs 115 may apply an OCC to a set of data (e.g., an interlace sequence) that is to be transmitted during the more than one symbol period 215 allocated for the PSFCH 235. In such example, each UE 115 (e.g., each UE 115 configured for sidelink communication) may be assigned a OCC of a set of OCCs. The UE 115 may determine its OCC based on an OCC index received via RRC, a source ID (e.g., ID of the UE 115 transmitting the sidelink message 245), a zone ID, or an OCC index received via sidelink control information (SCI).

In one example, the set of data may be repeated in the more than one symbol period 215 and the UE 115-a may apply a time-domain (TD)-OCC (e.g., a TD-OCC assigned to the UE 115-a) to the more than one symbol period 215. In another example, a first subset of the set of data (e.g., repetitions of the first subset) may be in a first symbol period 215 of the PSFCH 235 and a second subset of the set of data (e.g., repetitions of the second subset) may be in a second symbol period 215 of the PSFCH 235 (e.g., subsequent to the first symbol period 215) and the UE 115 may apply a frequency domain (FD)-OCC (e.g., FD-OCC assigned to the UE 115) to the more than one symbol periods 215. In either case, the UE 115-a may transmit the feedback message 250 to the UE 115-b and the UE 115-b may decipher the feedback message 250 (e.g., determine the origin of the feedback message 250 and the contents of the feedback message 250) using the interlace sequence, the OCC, and the cyclic shift pair assigned to the UE 115-a. Applying the OCC (e.g., TD-OCC or FD-OCC) to the set of data may allow two or more UEs 115 to share an interlace sequence which may increase the UE multiplexing capacity.

In another example, the UE 115 may increase the sequence length of the set of data such that the sequence length is greater than a single PRB (e.g., sequence length is greater than 12). In such example, a first subset of the set data (e.g., repetitions of subset of data with indices 0-11) may be in a first symbol period 215 of the PSFCH 235 and a second subset of the data (e.g., repetitions of the subset of data with indices 12-23) may be in a second symbol period 215 of the PSFCH 235. Increasing the sequence length of the set data may allow for more cyclic pairs (e.g., greater than 6) which may increase the resource pool of the PSFCH 235 and therefore, increase the UE multiplexing capacity.

As another example, the data may be arranged in the first symbol period and the second period according to a comb structure. For example, a first subset of the data (e.g., the subset of data with indices from 0-5) may be arranged in every other RE of a PRB of a first symbol period 215 of the PSFCH 235 and a second subset of the data (e.g., the subset of the data with indices from 6-11) may be arranged in every other RE of a PRB of a second symbol period 215 of the PSFCH 235. The unfilled REs of the PRBs may include a set of data for feedback of a different UE 115 and the PRBs may be repeated a number of times (10 times) in each symbol period 215.

In another example, the data may be arranged in the first symbol period and the second symbol period according to a FDM structure. For example, a first subset of the set of data (e.g., subset of data with indices from 0-5) may be arranged in consecutive REs of a PRB of the first symbol period (e.g., in a first portion of frequency of the PRB) and a second subset of the set of data (e.g., subset of data with indices from 6-11) may be arranged in consecutive REs of a PRB of the second symbol period (e.g., in the first portion of frequency of the PRB). Increasing the number of UEs 115 that can be multiplexed in a PRB may increase the resource pool for the PSFCH 235 and therefore, increase the UE multiplexing capacity.

Additionally or alternatively, an additional PSFCH occasion may be introduced in a subsequent slot of a slot that includes a PSFCH occasion. For example, in FIG. 2, a slot subsequent to the slot 210 may include one or more symbol periods 215 allocated for a second PSFCH 235. In such case, the PSFCH 235 may be known as the reference PSFCH and the second PSFCH 235 may be known as the additional PSFCH. Both the PSFCH 235 and the second PSFCH 235 may contribute to the same resource pool. As such, feedback messages 250 associated with sidelink messages 245 transmitted during one or more PSSCHs 225 associated with the PSFCH 235 may be transmitted using feedback resources of the second PSFCH 235. Establishing an additional PSFCH 235 may increase the resource pool and thus, increase UE multiplexing capacity.

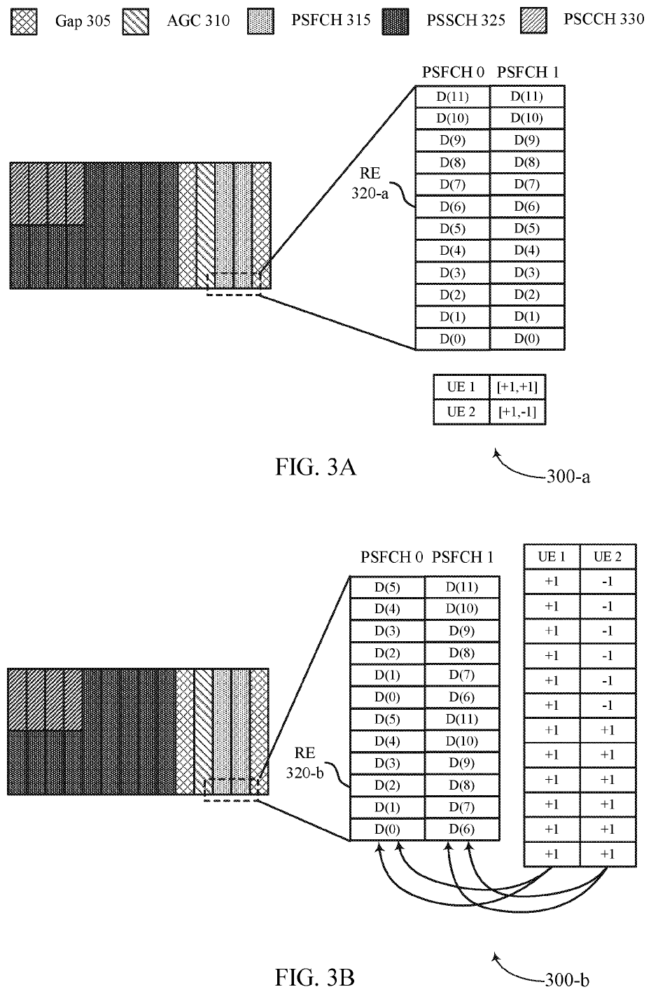

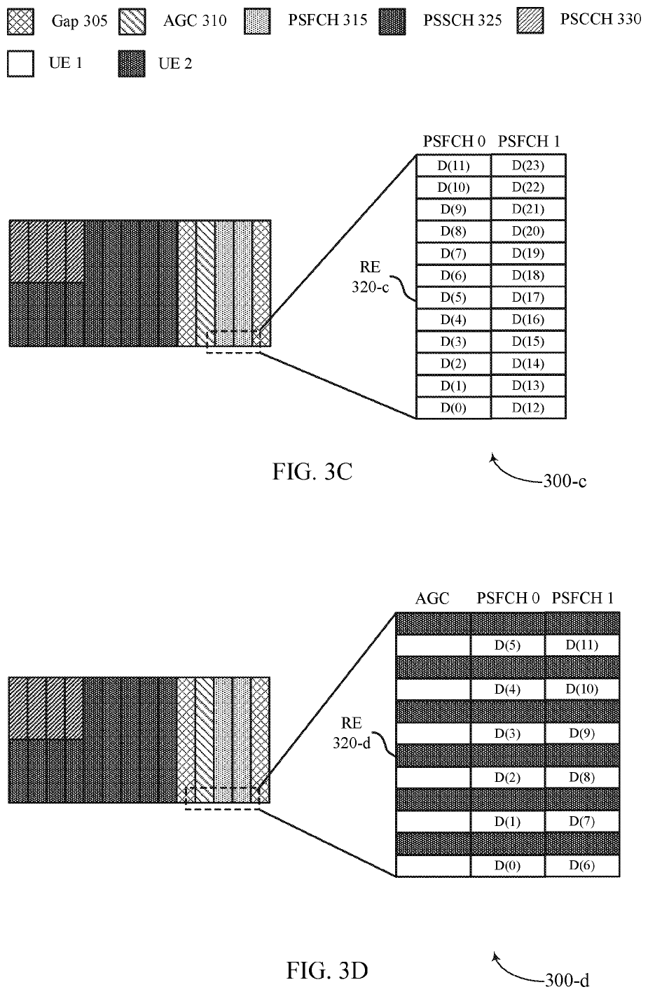

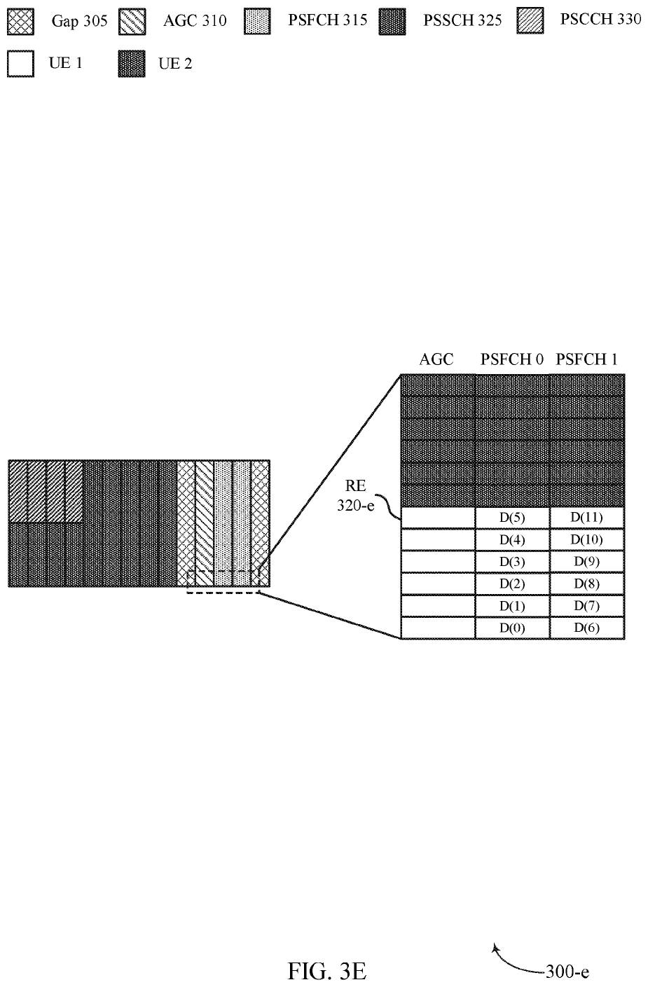

FIGS. 3A, 3B, 3C, 3D, and 3E illustrate examples of an interlace mapping scheme 300 (e.g., an interlace mapping scheme 300-a, an interlace mapping scheme 300-b, an interlace mapping scheme 300-c, an interlace mapping scheme 300-d, and an interlace mapping scheme 300-e) that supports capacity enhancement for interlaced sidelink feedback transmissions in accordance with one or more aspects of the present disclosure. In some examples, the interlace mapping scheme 300 may be implemented by aspects of a wireless communications system 100 and a wireless communications system 200. For example, the interlace mapping schemes 300 may be implemented by a UE 115 as described with reference to FIGS. 1 and 2.

As described herein, a set of UEs may be configured with a set of slots for sidelink communications. A subset of the set of slots may include different sets of symbol periods which may be allocated for different types of signaling. For example, a first set of symbol periods of a sidelink slot may be allocated for PSSCH 325 and PSCCH 330 and a second set of symbol periods of the sidelink slot may be allocated for PSFCH 315, AGC 310, and no signaling (e.g., a gap 305). FIGS. 3A, 3B, 3C, 3D, and 3E illustrate the second set of symbol periods and more specifically, a PSFCH 315 that occupies two consecutive in time symbol periods (e.g., a first symbol period (PSFCH 0) and a second symbol period subsequent to the first symbol period (PSFCH 1)). Additionally, FIGS. 3A, 3B, 3C, 3D, and 3E illustrate different schemes for mapping the set of data to REs 320 of a single PRB during a first symbol period and second symbol period. In some examples, the network entity 105 may identify which of the schemes the UE 115 is to apply for mapping the set of data to REs 320 may be indicated via an interlacing configuration indicated in control signaling (e.g., RRC signaling, a MAC CE, DCI, etc.). Although, FIGS. 3A, 3B, 3C, 3D, and 3E show a mapping scheme for REs 320 of a single PRB spanning the first symbol period and the second symbol period, it may be understood that a same mapping scheme may be repeated for other PRBs spanning the first symbol and the second symbol period. For example, if the 10 PRBs are allocated for feedback during the first symbol period and the second symbol period, the mapping may be repeated 10 times.

In the examples of FIGS. 3A, 3B, 3C, 3D, and 3E a set of sidelink UEs may include at least a first UE (UE 1), a second UE (UE 2), and a third UE. Each UE of the set of UEs may be assigned a set of data or an interlace sequence. In some examples, two or more UEs of the set may be assigned a same set of data. In another example, each UE of the set may be assigned a different set of data In one example, the third UE may transmit a first sidelink message to the first UE and additionally, transmit a second sidelink message to the second UE. The first UE and the second UE may monitor for their respective sidelink message and generate a feedback message (e.g., generate a set of interlaced feedback data symbols using one of the techniques discussed in FIGS. 3A, 3B, 3C, 3D, and 3E) associated with their respective sidelink message. The UE 105 may select an interlacing sequence (e.g., an acknowledgement sequence or a negative acknowledgement sequence) and optionally a cyclic shift to the interlacing sequence, and then modulate the interlacing sequence to generate a set of interlaced feedback data symbols. The interlaced feedback data symbols may be transported on the REs 320 in two or more symbol periods using one of the techniques discussed in FIGS. 3A, 3B, 3C, 3D, and 3E. In an example, the first UE and the second UE may then transmit the generated feedback message to the third UE during the first symbol period and the second symbol period of the PSFCH 315.

In FIG. 3A, each UE of the set of UEs may be assigned a unique TD-OCC. As an example, the first UE may be assigned an TD-OCC of [+1,+1] and the second UE may be assigned an TD-OCC of [+1,−1]. The TD-OCC assigned to the first UE may be orthogonal to the TD-OCC assigned to the second UE. Moreover, a same set of data (e.g., a same interlace sequence) may be assigned to the first UE and the second UE and a unique CS shift pair may be assigned to each of the first UE and the second UE (e.g., a CS pair including one CS for NACK and one CS for ACK). The set of data may have a sequence length of 12 and may be indexed from 0 to 11. When generating the feedback message (e.g., generating the set of interlaced data symbols), the first UE and the second UE may map the set of data to REs 320-a of the first symbol period and a repetition of the set of data to REs 320-a of the second symbol period and apply their respective TD-OCC to the set of data mapped to REs 320-a of the first symbol period and the repetition of the set of data mapped to REs 320-a of the second symbol. For example, the first UE may multiply the set of data of the first symbol period by +1 and the set of data of the second symbol period by +1. Alternatively, the second UE may multiply the set of data of the first symbol period by +1 and the set of data of the second symbol period by −1. The first UE and the second UE may then transmit their respective feedback messages (e.g., interlaced feedback message) to the third UE during the first symbol period and the second symbol period. The third UE may receive the interlaced feedback message and determine the feedback information (e.g., ACK/NACK) from the first UE and the second UE. As an example, The third UE may determine the feedback information from the first UE by applying the TD-OCC assigned to the first UE to the interlaced feedback message. Because the TD-OCCs are orthogonal, applying the TD-OCC assigned to the first UE may cancel the feedback information form the second UE. Using the above method, PSFCH data symbols (e.g., the set of interlaced data symbols), may be repeated 2 or 4 times when a OCC of length 2 or 4 is applied. As such, the UE multiplexing capacity may be increased 2 or 4 times because the PSFCH resource pool considers the OCC size.

In FIG. 3B, each UE of the set of UEs may be assigned a unique FD-OCC. Moreover, a same set of data (e.g., a same interlace sequence) may be assigned to the first UE and the second UE and a unique CS shift pair may be assigned to each of the first UE and the second UE (e.g., a CS pair including one CS for NACK and one CS for ACK). The set of data may have a sequence length of 12 and may be indexed from 0 to 11. Each symbol period may include 12/N unique modulation symbols, where N is the number of symbol periods allocated for the PSFCH 315. In the example of FIG. 3B, the PSFCH 315 may occupy 2 symbol periods and as such, each symbol period may include 6 unique modulation symbols. For example, the REs 320-b of the first symbol period may include a subset of the data indexed from 0-5 and a repetition of the subset of data indexed from 0-5 and the REs 320-b of the second symbol period may include subset of the data indexed from 6-11 and a repetition of the subset of the data indexed from 6-11.

When generating the feedback message (e.g., generating the set of interlaced data symbols), each modulation symbol may undergo block-wise spreading with an orthogonal sequence (e.g., FD-OCC). Spreading factors of 2 and 4 may be supported which may allow for two or four UEs to be multiplexed on a same set of PRBs. As an example, for a spreading factor of two, the first UE may apply an FD-OCC of [+1, +1, +1, +1, +1, +1, +1, +1, +1, +1, +1, +1] to the data of the first symbol period and the second symbol period and the second UE may apply an FD-OCC of [+1, +1, +1, +1, +1, +1, −1, −1, −1, −1, −1, −1] to the data of first symbol period and the second symbol period. If the PSFCH were to occupy 4 symbol periods, a spreading factor of four may be used and the possible FD-OCCs applied to REs 320-b of each of the 4 symbol periods may be [+1, +1, +1, +1, +1, +1, +1, +1, +1, +1, +1, +1], [+1, +1, +1, −j, −j, −j, −1, −1, −1, +j, +j, +j], [+1, +1, +1, +j, +j, +j, −1, −1, −1, −j, −j, −j], and [+1, +1, +1, −1, −1, −1, +1, +1, +1, −1, −1, −1]. The first UE and the second UE may then transmit their respective feedback messages (e.g., interlaced feedback message) to the third UE during the first symbol period and the second symbol period. The UE may receive the interlaced feedback message and determine the feedback information (e.g., ACK/NACK) from the first UE and the second UE. As an example, the third UE may determine the feedback information from the first UE by applying the FD-OCC assigned to the first UE to the interlaced feedback message. Because the FD-OCC sequences are orthogonal, applying the FD-OCC assigned to the first UE may cancel the feedback information from the second UE. The above method may increase the multiplexing capacity of the PSFCH 2 or 4 times because the PSFCH resource pool considers the OCC size.

In FIG. 3C, each UE of the set of UEs may be assigned a unique set of data (e.g., unique interlace sequence). A sequence length of the set of data may depend on a number of symbol periods allocated for the PSFCH 315. For example, the sequence length of the set of data may be equal to 12*N, where N is the number of symbol periods allocated for the PSFCH 315. In the example of FIG. 3C, the symbol periods allocated for the PSFCH 315 is 2. As such, the first UE or the second UE may be assigned a set of data having a sequence length of 24 and indexed from 0-23. REs 320-c of the first symbol period may include a first subset of the set of data and a REs 320-c of the second symbol period may include a second subset of the set of data.

In some examples, when generating the feedback transmission (e.g., generating the set of interlaced data symbols), the first UE may map its respective set of data to the RE 320-c of the symbol periods in a frequency domain first and time domain second fashion. In such example, the REs 320-c of the first symbol period may include the data indexed from 0-11 and the RE 320-c of the second symbol period may include the data indexed from 12-23. In another example, the first UE may map its respective set of data to the RE 320-c of the symbol periods in a time domain first and frequency domain second fashion. In such example, the REs 320-c of the first symbol period may include, from bottom to top, the data of indices 0, 2, 4, 6, 8, 10, 12. 14. 18, 20, and 22 and the REs 320-c may include, from bottom to top, the data of indices 1, 3, 5, 7, 9, 11, 13, 15, 17, 19, 21, and 23. Additionally, the number of CS pairs may depend on the number symbol periods over which the set of data spans. As such, in this case the number of CS pair may be equal to 6*N, where N is the number of symbol periods. In FIG. 3C, the number of period symbols may be equal to 2 and as such, the number of CS pairs may be equal to 12. The first UE may transmit their respective feedback messages to the third UE during the first symbol period and the second symbol period. The third UE may receive the feedback message and determine the feedback information (e.g., ACK/NACK) from the first UE using its knowledge of the set of data and the CS pair assigned to the first UE. Thus, the UE or PSFCH multiplexing capacity may be increased by N times.

In FIG. 3D, a same set of data (e.g., a same interlace sequence) may be assigned to the first UE and the second UE and a unique CS shift pair may be assigned to each of the first UE and the second UE (e.g., a CS pair including one CS for NACK and one CS for ACK). The set of data may have a sequence length of 12 and may be indexed from 0 to 11. The set of data may be mapped to each RE 320-d of the first symbol period and the second symbol period according to a comb structure. The comb structure may depend on the number of symbol periods allocated for the PSFCH 315. For example, the comb structure may be a comb-N, where N is equal to the number of symbol periods allocated for the PSFCH 315. In the example of FIG. 3D, the symbol periods allocated for the PSFCH 315 may be equal to 2. As such, the combs structure may include a comb-2 structure. That is, every other RE 320-d may be allocated for the set of data assigned to the first UE. The same comb structure may be applied to AGC.

In some examples, when generating the feedback transmission (e.g., generating the set of interlaced data symbols), the first UE may map the set of data to the RE 320-d of the symbol periods in a frequency domain first and time domain second fashion. In such example, the REs 320-d of the first symbol period (e.g., every other RE 320-d in the frequency domain from bottom to top) may include the data indexed from 0-5 and the REs 320-d of the second symbol period (e.g., every other RE 320-d in the frequency domain from bottom to top) may include the data indexed from 6-11. In another example, the first UE may map the set of data to the RE 320-d of the symbol periods in a time domain first and frequency domain second fashion. In such example, every other RE 320-d of the first symbol period may include the data of indices 0, 2, 4, 6, 8, and 10 and every other REs 320-d of the second symbol period may include the data of indices 1, 3, 5, 7, 9, and 11. The second UE may map the set of data to the remaining REs 320-d of the first symbol period and the second symbol period in a similar way. The first UE and the second UE may then transmit their respective feedback messages (e.g., interlaced feedback message) to the third UE during the first symbol period and the second symbol period. The third UE may receive the interlaced feedback message and determine the feedback information (e.g., ACK/NACK) from the first UE and the second UE. As an example, the third UE may determine the feedback information from the first UE using the comb-2 structure. Using the above method, the UEs may multiplex the PSFCH waveform with N combs which may increase the UE multiplexing capability by N times because the PSFCH resource pool may consider the comb size.

In FIG. 3E, a same set of data (e.g., a same interlace sequence) may be assigned to the first UE and the second UE and a unique CS shift pair may be assigned to each of the first UE and the second UE (e.g., a CS pair including one CS for NACK and one CS for ACK). The set of data may have a sequence length of 12 and may be indexed from 0 to 11. The set of data may be mapped to each RE 320-e of the first symbol period and the second symbol period according to a FDM scheme. As an example, a first subset of the set of data may occupy a first frequency range (e.g., consecutive REs 320-e) of the first symbol period and a second subset of the set of data may occupy the first frequency range (e.g., consecutive REs 320-e) of the second symbol period. That is, the PSFCH for a UE is confined within 12/N REs 320-e and N symbol periods. The same FDM scheme may be applied to AGC.

In some examples, when generating the feedback message (e.g., generating the set of interlaced data symbols), the first UE may map the set of data to the RE 320-e of the symbol periods in a frequency domain first and time domain second fashion. For example, as shown in FIG. 3E, the first UE may map the data indexed from 0-5 to consecutive REs 320-e (e.g., 6 consecutive REs 320-e) of the first symbol period and map the data indexed from 6-11 to consecutive REs 320-e of the second symbol period. In another example, the first UE may map the set of data to the RE 320-e of the symbol periods in a time domain first and frequency domain second fashion. In such example, the first UE may map the data with indices 0, 2, 4, 6, 8, and 10 to consecutive REs 320-e (e.g., 6 consecutive REs 320-e) of the first symbol period and map the data with indices 1, 3, 5, 7, 9, and 11 to consecutive REs 320-e of the second symbol period. The second UE may map the set of data to the remaining REs 320-e of the first symbol period and the second symbol period in a similar way. The first UE and the second UE may then transmit their respective feedback messages (e.g., interlaced feedback message) to the third UE during the first symbol period and the second symbol period. The third UE may receive the interlaced feedback message and determine the feedback information (e.g., ACK/NACK) from the first UE and the second UE. As an example, the third UE may determine the feedback information from the first UE using the FDM scheme. Using the above methods, the UEs may multiplex the PSFCH waveform with different REs 320-e which may increase the UE multiplexing capacity by N times because the PSFCH resource may consider the number of UEs that can be multiplexed in one RB,

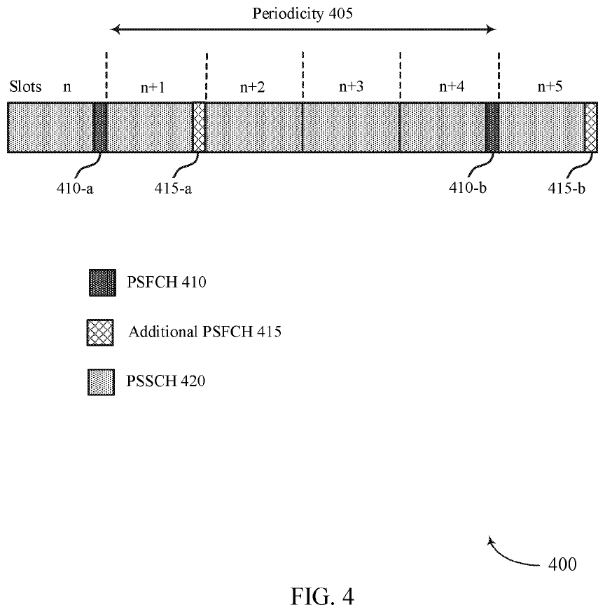

FIG. 4 illustrates an example of a PSFCH slot layout 400 that supports capacity enhancement for interlaced sidelink feedback transmissions in accordance with one or more aspects of the present disclosure. In some examples, the PSFCH slot layout 400 may be implemented by aspects of a wireless communications system 100 and a wireless communications system 200. For example, the PSFCH slot layout 400 may be implemented by a UE 115 as described with reference to FIGS. 1 and 2.

As described with reference to FIG. 2, a set of UEs participating in sidelink communication may receive control signaling indicating a set of sidelink resources. The set of sidelink resources may include a set of slots and a subset of the set of slot may include a PSFCH 410 that occupies one or more symbol periods. The set of UEs may utilize resources of the PSFCH 410 to transmit feedback (e.g., ACK/NACK) responsive to a data message received via resources of a PSSCH 420 in a previous slot. As such, the PSFCH 410 may be associated with one or more PSSCHs 420 or slots that include PSSCH resources.

In some examples, the control signaling may also include one or more parameters that further define the PSFCH 410. For example, a first parameters of the one or more parameters may indicate a number of slots associated with the PSFCH 410 (e.g., sl-MinTimeGapPSFCH-r16). Specifically, the first parameter may indicate a number slots between a slot with a PSSCH transmission and a slot including the PSFCH 410 with a feedback transmission for the PSSCH transmission. In one example, the first parameter may be equal to 2. In such example, UEs that receive a data message via PSSCH resources of the slot n, the slot n+1, or the slot n+2 may transmit feedback for the data message via resources of the PSFCH 410-b. Further, a second parameter of the one or more parameters may indicate a periodicity 405 of the PSFCH 410 (e.g., sl-PSFCH-Period-r16). In the example of FIG. 4, the second parameter may be equal to 4. As such, PSFCH 410 may be present in slot n and slot n+4.

As described herein, an additional PSFCH occasion may be added in a slot subsequent to a slot that includes a preexisting or preconfigured PSFCH 410. As shown in FIG. 4, the set of UEs may receive control signaling indicating that the slots n and the slot n+4 may include the PSFCH 410. For each slot that includes the PSFCH 410, the set of UEs may identify a subsequent slot that includes an additional PSFCH 415. For example, as shown in FIG. 4, the slot n+1 may include an additional PSFCH 415-a and the slot n+5 may include the additional PSFCH 415-b. In some examples, the additional PSFCH 415 may be enabled or activated via RRC or configured at the resource pool level.

The PSFCH 410 and the corresponding additional PSFCH (e.g., the PSFCH 410-a and the additional PSFCH 415-a) may be known as a single PSFCH group and the first PSFCH of the PSFCH group (e.g., the PSFCH 410-a and the PSFCH 410-b) may be known as the reference PSFCH. A PSFCH 410 and an additional PSFCH 415 that is included in the PSFCH group may collectively share a resource pool. That is, both the PSFCH 410 and the additional PSFCH 415 in a slot subsequent to the slot including the PSFCH 410 may contribute to the resource pool. As an example, UEs that receive a data message via PSSCH resources of the slot n, the slot n+1, or the slot n+2 may select resources for transmitting feedback for the data messages from a resource pool that take into account the resources of the PSFCH 410-b and the resources of the additional PSFCH 415-b. The one or more parameters included in the control signaling may define aspects the PSFCH groups. For example, the first parameters may indicate a number slots between a slot with a PSSCH transmission and a slot including the reference PSFCH with a feedback transmission for the PSSCH transmission (e.g., sl-MinTimeGapPSFCH-r16) and the second parameter may indicate a PSFCH period between two reference PSFCH slots (e.g., sl-PSFCH-Period-r16).

As described with reference to FIG. 2, the set of UE may determine the resource pool by multiplying a number of PSFCH types

$$( e . g . , {N}_{type}^{PSFCH} )$$

by a number of cyclic shift pairs

$$( e . g . , {N}_{CS}^{PSFCH} )$$

by a number of PRBs per subchannel and slot

$$( e . g . , {M}_{subch , slot}^{PSFCH} ) .$$

In the example of FIG. 4,

$${M}_{subch , slot}^{PSFCH}$$

may be a number of PRBs and PSFCH occasions within one PSFCH group as opposed to a single PSFCH. As a result, the resource pool may increase which in turn will allow for more UEs to transmit feedback for a given PSFCH occasion.

In an example, a PSFCH resource of a PSFCH group (e.g., a feedback channel group) may considered to include both a reference slot and an additional slot (e.g., slot n and slot n+1). The PSFCH 410 and 415 may be considered a PSFCH group. Multiple UEs 115 may use the resource of PSFCH 410 and 415. A PSFCH resource used by a first UE and a second UE may be determined based on the formula

$$( {P}_{ID} + {M}_{ID} ) mod {R}_{PRB , CS}^{PSFCH} .$$

As such, the first UE's PSFCH may be in the PSFCH 415 in the later slot n+1, and not in the earlier slot n (e.g., in the additional slot rather than in the reference slot). The second UE's PSFCH may be in the reference slot n. In some examples, the parameter sl-MinTimeGapPSFCH-r16 may be reinterpreted as a defined (e.g., minimum) number of slots within a resource pool between a slot with a PSSCH transmission and a slot containing reference PSFCH for feedback (e.g., HARQ feedback) for the PSSCH transmission.

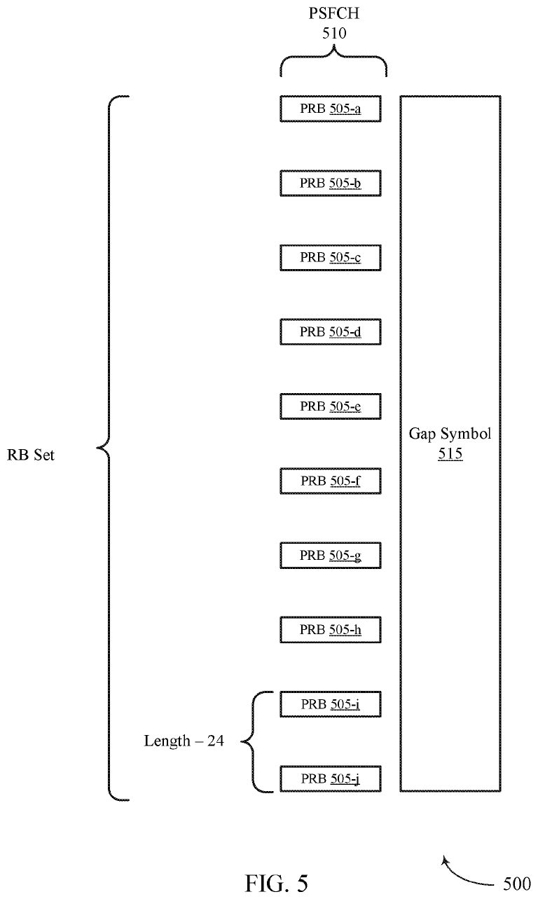

FIG. 5 illustrates an example of an interlaced PSFCH 500 that supports capacity enhancement for interlaced sidelink feedback transmissions in accordance with one or more aspects of the present disclosure. In some examples, the interlaced PSFCH 500 may be implemented by aspects of a wireless communications system 100 and a wireless communications system 200. For example, the interlaced PSFCH 500 may be implemented by a UE 115 as described with reference to FIGS. 1 and 2.

As described with reference to FIG. 2, a sidelink slot (e.g., slot allocated for sidelink communication) may include a PSFCH 510 or a set of resources for transmitting feedback responsive of received sidelink data messages. The PSFCH 510 may occupy one or more symbols periods. Further, as shown in FIG. 5, a symbol period allocated for a gap 515 may be subsequent to the one or more symbol periods allocated for the PSFCH 510. In some examples, the PSFCH 510 may be an example of an interlaced PSFCH 510. In such example, the PSFCH 510 may span a set of PRBs 505. As illustrated in FIG. 5, the set of PRBs 505 may include a PRB 505-a, a PRB 505-b, a PRB 505-c, a PRB 505-d, a PRB 505-e, a PRB 505-f, a PRB 505-g, a PRB 505-h, a PRB 505-i, and a PRB 505-j (e.g., 10 PRBs 505).

In the case that the PSFCH 510 is an interlaced PSFCH, each UE in a set of sidelink UEs (e.g., UEs participating in sidelink communication) may receive or be assigned an interlace sequence of a set of interlace sequences. In some examples, the interlace sequences of the set of interlace sequences may each have a sequence length that exceeds a PRB 505 (e.g., has a sequence length greater than 12). In some examples, the sequence length may be fixed (e.g., preconfigured at the UE). Alternatively, the sequence length may change or be updatable (e.g., configured via RRC and updated via DCI or SCI). In one example, the sequence length may be equal to 24 (e.g., a PUSCH Formant 0 (PFO) interlace sequence having a length of 24 bits). In such example, when generating feedback responsive to a past PSSCH transmission, a UE may map its respective interlace sequence to pairs of PRBs in the set of PRB of the PSFCH 510. For example, the UE map the interlace sequence to the PRBs 505-j and the PRB 505-i and the UE may map repetitions of the interlace sequence to the remaining PRB pairs (e.g., the PRB 505-h and the PRB 505-g).

Increasing the sequence length (e.g., from 12 to 24) may allow for more CS pairs and root sequences. For example, increasing the sequence length of an interlaced RB (IRB) PSFCH sequence may support more cyclic shift and root sequences within a PSFCH symbol. As described with reference to FIG. 2, the set of sidelink UEs may determine the resource pool by multiplying a number of PSFCH types

$$( e . g . , {N}_{type}^{PSFCH} )$$

by a number of cyclic shift pairs

$$( e . g . , {N}_{CS}^{PSFCH} )$$

by a number of PRBs per subchannel and slot

$$( e . g . , {M}_{subch , slot}^{PSFCH} ) .$$

In the example of FIG. 5,

$${M}_{subch , slot}^{PSFCH}$$

may be a number of PRBs and a number of root sequences for the PSFCH 510. As a result, the resource pool may increase which in turn will allow for more UEs to transmit feedback for a given PSFCH occasion. In an example, PSFCH resource pool size may be based on a number of root sequences. For example, a PSFCH resource pool is of size:

$${R}_{PRB , CS}^{PSFCH} = {N}_{type}^{PSFCH} \times {N}_{CS}^{PSFCH} \times {M}_{subch , slot}^{PSFCH}$$

where each subchannel/slot has

$${M}_{subch , slot}^{PSFCH} = \frac{{M}_{PRB , set}^{PSFCH}}{{N}_{PSSCH}^{PSFCH} \times {N}_{subch}} PRBs , and {M}_{PRB , set}^{PSFCH}$$

may refer to a set of PRBs and the number of root sequences in a resource pool for PSFCH in a slot.

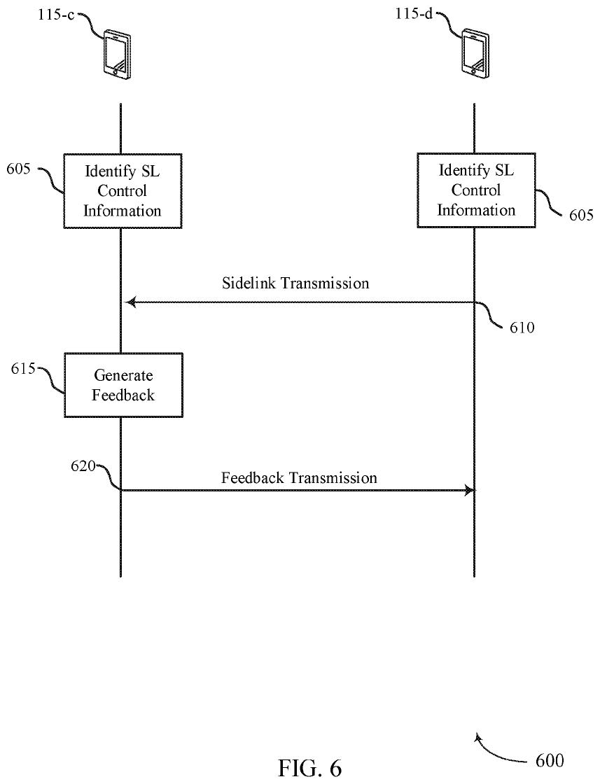

FIG. 6 illustrates an example of a process flow 600 that supports capacity enhancement for interlaced sidelink feedback transmissions in accordance with one or more aspects of the present disclosure. In some examples, the process flow 600 may include aspects of a wireless communications system 100 and a wireless communications system 200. For example, the process flow 600 may include a UE 115-c and a UE 115-d which may be an example of UEs 115 as described with reference to FIGS. 1 and 2. Alternative examples of the following may be implemented, where some steps are performed in a different order than described or are not performed at all.

At 605, the UE 115-c and the UE 115-d may identify sidelink control information. In some examples, the UE 115-c and the UE 115-d may receive the sidelink control information from a network entity. In some examples, the sidelink control information may indicate a set of slots within a sidelink channel. A subset of the set of slots may include a set of sidelink resources (e.g., a PSSCH or a PSSCH) and a set of sidelink feedback resources (e.g., a PSFCH). In some examples, the set of sidelink resources may occupy one symbol periods or more than one symbol period (e.g., a first symbol period and a second symbol period subsequent to the first symbol period). In such example, the sidelink control information may additionally include an interlacing configuration for multiplexing feedback from different UEs in the more than one symbol period. Further, the sidelink control information may include an indication of an OCC (e.g., FD-OCC or TD-OCC). Additionally, the control information may include information that further defines the PSFCH. For example, the control information may indicate the number of symbol periods allocated for PSFCH.

Alternatively or additionally, the control signaling may active or indicate a feedback channel group (e.g., sets of sidelink feedback resources that corresponds to at least two consecutive slots of the subset of slots). Feedback resources in a first slot of the feedback channel group (e.g., first slot in time) may be known as a reference PSFCH and feedback resources in subsequent slots of the feedback channel group may be known as additional PSFCHs. In such example, the sidelink control information may further include a parameter that indicates a defined number of slots between a slot including a set of sidelink resources (e.g., a PSSCH) and the slot comprising the reference PSFCH. Additionally, the sidelink control information may include a parameter that indicates a number of slots between reference PSSCHs of different feedback channel groups (e.g., a periodicity).

At 610, the UE 115-d may transmit a sidelink transmission to the UE 115-d. In some examples, the UE 115-d may transmit the sidelink transmission using a set of sidelink resources of a slot of the set of slots within the sidelink channel (e.g., the PSSCH). In some examples, prior to transmitting the sidelink transmission, the UE 115-d may receive a sidelink resource grant (e.g., from the network entity) allocating resources of a PSSCH for transmission of the sidelink transmission.

At 615, the UE 115-c may generate feedback (e.g., ACK/NACK) responsive to the sidelink transmission received at 610 over resources of the PSSCH (e.g., generate a set of interlaced data symbols). In some examples, the PSFCH may occupy two or more symbol periods (e.g., a first symbol period and a second symbol periods). In such example, to generate the feedback, the UE 115-c may map a set of interlaced data symbols (e.g., an interlace sequence) to REs of a single RB (e.g., a frequency range) of the PSFCH. In one example, the UE 115-c may map the set of interlaced data symbols to REs of the first symbol period of the PSFCH and map a repetition of the set of interlaced data symbols to REs of the second symbol period. Additionally, the UE 115-c may apply a TD-OCC to the interlaced data symbols as illustrated in FIG. 3A. Alternatively, the UE 115-c may map a first subset of set of interlace data symbols and a repetition of the first subset of the set of interlaced data symbols to REs of the first symbol period and map a second subset of set of interlace data symbols and a repetition of the second subset of the set of interlaced data symbols to REs of the second symbol period. Additionally, the UE 115-c may apply an FD-OCC to the interlaced data symbols as illustrated in FIG. 3B. Alternatively, the UE 115-c may map a first subset of the set of interlaced data symbols to REs of the first symbol period and a second subset of the set of interlaced data symbol to REs of the second symbol period as illustrated in FIG. 3C.

Alternatively, the UE 115-c may map the set of interlaced data symbols to REs of the first symbol period and the symbol period that occupy a portion of the frequency range (e.g., a portion of the frequency that corresponds to an RB). In such example, the set of interlaced data symbols may be mapped according to a comb structure (e.g., comb-2) as illustrated in FIG. 3D or a FDM scheme as illustrated in FIG. 3E. The mapping scheme may be repeated for all the RBs that make up the PSFCH. In another example, a sequence length for the set of interlaced data symbols may exceeds a single RB (e.g., sequence length may be greater than 12) as illustrated in FIG. 5. For example, the sequence length may correspond to a number of REs in two RBs (e.g., have a sequence length of 24). In such example, the UE 115-c may map the set of interlaced data symbols to the REs of more than one RB of the PSFCH using similar mapping schemes as described herein. In some examples, the sidelink control signaling may further include an indication of the sequence length. Additionally, the UE 115-c may update the sequence length based on environmental characteristics of the UE 115-c. For example, if the UE 115-c moves from being in an outdoor environment to being in an indoor environment, the UE 115-c may update the sequence length from 12 to 24. In an indoor environment, the multiple delay spread is smaller (e.g., than an outdoor environment). As such, the coherent bandwidth is much smaller and it may be possible to increase the sequence length to support more cyclic shifts and root sequences.

At 620, the UE 115-c may transmit a feedback transmission to the UE 115-d over feedback resources of the PSFCH. The feedback transmission may indicate whether the UE 115-c successfully received and decoded the sidelink transmission at 610. The resources used to receive the sidelink transmission may be in the same slot as the PSFCH or in an earlier slot. In some examples, feedback transmission may be based on repetitions of the set of interlaced data symbols assigned to the UE 115-c (e.g., interlace sequence). In some examples, the PSFCH may be included in a feedback channel group. In such example, the UE 115-c may transmit the feedback transmission to the UE 115-d over feedback resources of the reference PDSCH or the additional PDSCH.

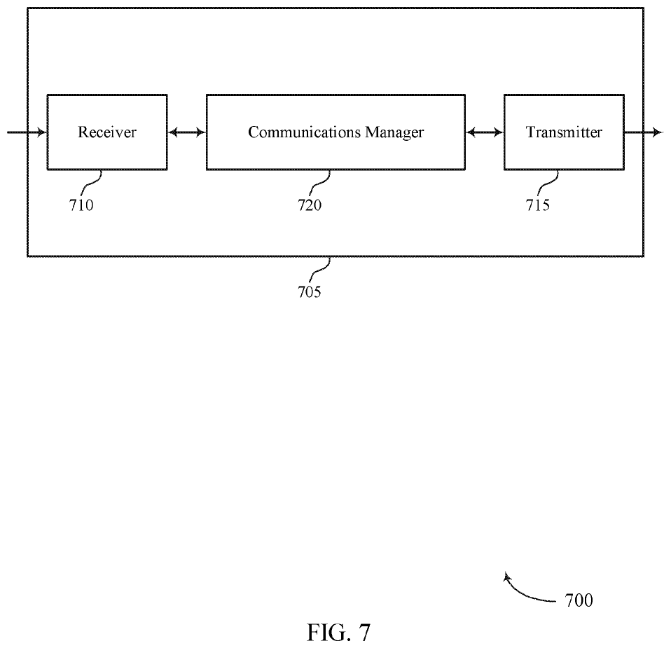

FIG. 7 shows a block diagram 700 of a device 705 that supports capacity enhancement for interlaced sidelink feedback transmissions in accordance with one or more aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the sidelink feedback capacity enhancement features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to capacity enhancement for interlaced sidelink feedback transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to capacity enhancement for interlaced sidelink feedback transmissions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of capacity enhancement for interlaced sidelink feedback transmissions as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. For example, the communications manager 720 may be configured as or otherwise support a means for receiving, from a second UE, sidelink signaling via a set of resources of a sidelink channel. The communications manager 720 may be configured as or otherwise support a means for generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel. The communications manager 720 may be configured as or otherwise support a means for transmitting, to the second UE within the frequency range via the first symbol period and the second symbol period, a feedback transmission based on the set of multiple interlaced feedback data symbols.

Additionally, or alternatively, the communications manager 720 may support wireless communication at a first UE in accordance with examples as disclosed herein. For example, the communications manager 720 may be configured as or otherwise support a means for receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group. The communications manager 720 may be configured as or otherwise support a means for receiving a sidelink transmission via a first set of sidelink resources of a slot of the subset of slots. The communications manager 720 may be configured as or otherwise support a means for transmitting a feedback transmission associated with the sidelink transmission via a first feedback resource of the feedback channel group or a second feedback resource of the feedback channel group.

Additionally, or alternatively, the communications manager 720 may support wireless communication at a first UE in accordance with examples as disclosed herein. For example, the communications manager 720 may be configured as or otherwise support a means for receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period. The communications manager 720 may be configured as or otherwise support a means for receiving, from a second UE, a sidelink transmission via a set of resources of the first set of symbols. The communications manager 720 may be configured as or otherwise support a means for transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

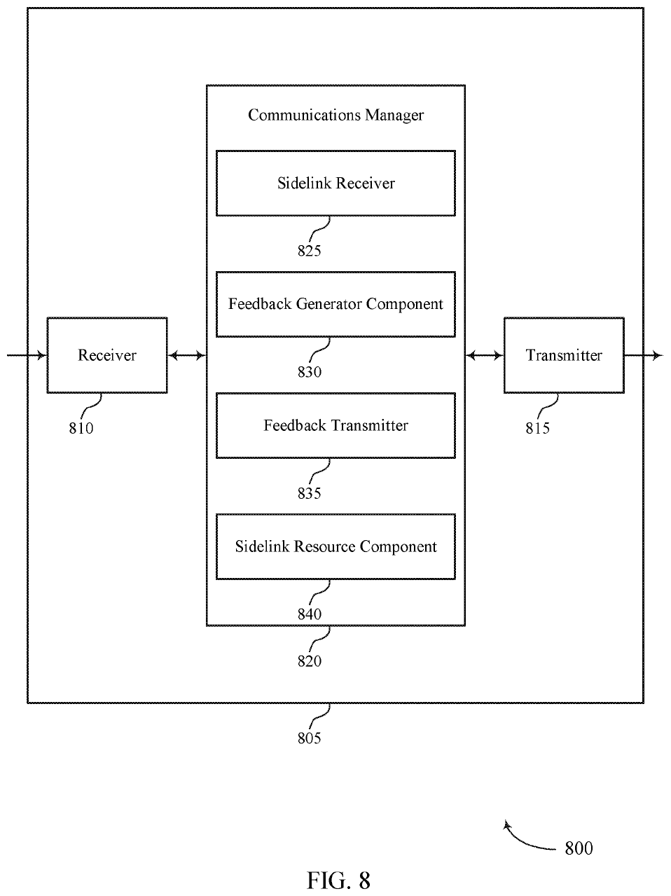

FIG. 8 shows a block diagram 800 of a device 805 that supports capacity enhancement for interlaced sidelink feedback transmissions in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to capacity enhancement for interlaced sidelink feedback transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to capacity enhancement for interlaced sidelink feedback transmissions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of capacity enhancement for interlaced sidelink feedback transmissions as described herein. For example, the communications manager 820 may include a sidelink receiver 825, a feedback generator component 830, a feedback transmitter 835, a sidelink resource component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a first UE in accordance with examples as disclosed herein. The sidelink receiver 825 may be configured as or otherwise support a means for receiving, from a second UE, sidelink signaling via a set of resources of a sidelink channel. The feedback generator component 830 may be configured as or otherwise support a means for generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel. The feedback transmitter 835 may be configured as or otherwise support a means for transmitting, to the second UE within the frequency range via the first symbol period and the second symbol period, a feedback transmission based on the set of multiple interlaced feedback data symbols.

Additionally, or alternatively, the communications manager 820 may support wireless communication at a first UE in accordance with examples as disclosed herein. The sidelink resource component 840 may be configured as or otherwise support a means for receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group. The sidelink receiver 825 may be configured as or otherwise support a means for receiving a sidelink transmission via a first set of sidelink resources of a slot of the subset of slots. The feedback transmitter 835 may be configured as or otherwise support a means for transmitting a feedback transmission associated with the sidelink transmission via a first feedback resource of the feedback channel group or a second feedback resource of the feedback channel group.

Additionally, or alternatively, the communications manager 820 may support wireless communication at a first UE in accordance with examples as disclosed herein. The sidelink resource component 840 may be configured as or otherwise support a means for receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period. The sidelink receiver 825 may be configured as or otherwise support a means for receiving, from a second UE, a sidelink transmission via a set of resources of the first set of symbols. The feedback transmitter 835 may be configured as or otherwise support a means for transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

In some cases, the sidelink receiver 825 and the feedback generator component 830 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the sidelink receiver 825 and the feedback generator component 830 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

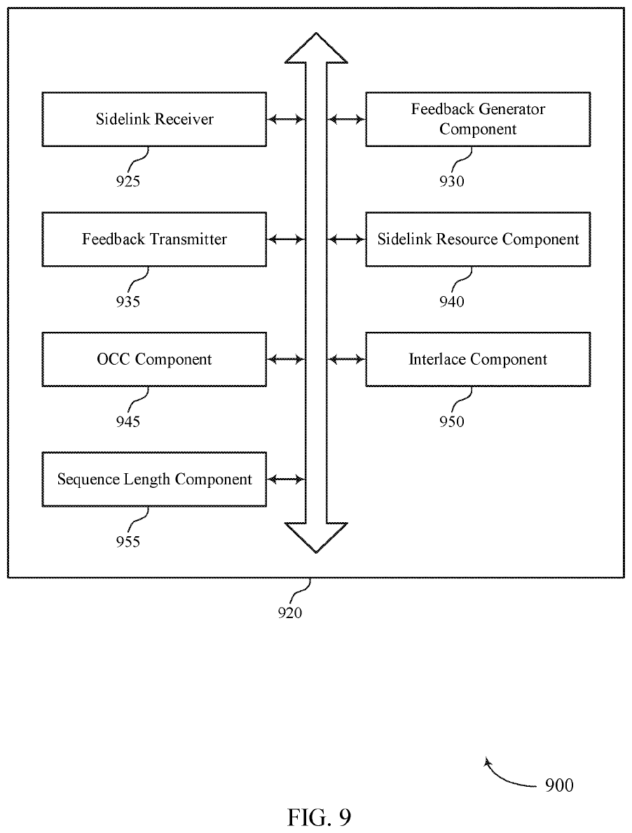

FIG. 9 shows a block diagram 900 of a communications manager 920 that supports capacity enhancement for interlaced sidelink feedback transmissions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of capacity enhancement for interlaced sidelink feedback transmissions as described herein. For example, the communications manager 920 may include a sidelink receiver 925, a feedback generator component 930, a feedback transmitter 935, a sidelink resource component 940, a OCC component 945, an interlace component 950, a sequence length component 955, or any combination thereof. Each of these components may communicate, directly or indirectly, with one another (e.g., via one or more buses).

The communications manager 920 may support wireless communications at a first UE in accordance with examples as disclosed herein. The sidelink receiver 925 may be configured as or otherwise support a means for receiving, from a second UE, sidelink signaling via a set of resources of a sidelink channel. The feedback generator component 930 may be configured as or otherwise support a means for generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel. The feedback transmitter 935 may be configured as or otherwise support a means for transmitting, to the second UE within the frequency range via the first symbol period and the second symbol period, a feedback transmission based on the set of multiple interlaced feedback data symbols.

In some examples, the feedback generator component 930 may be configured as or otherwise support a means for generating the feedback transmission based on applying an OCC to the set of multiple interlaced feedback data symbols across the first symbol period and the second symbol period in accordance with the interlacing configuration. In some examples, the OCC includes a TD-OCC or a FD-OCC.

In some examples, the OCC component 945 may be configured as or otherwise support a means for receiving control signaling indicating an OCC of a set of multiple OCCs, the OCC assigned to the first UE.

In some examples, the feedback generator component 930 may be configured as or otherwise support a means for generating the set of multiple interlaced feedback data symbols based on an interlace sequence indicated in the interlacing configuration.

In some examples, to support transmitting the feedback transmission, the feedback transmitter 935 may be configured as or otherwise support a means for transmitting, in accordance with the interlacing configuration, the set of multiple interlaced feedback data symbols during the first symbol period and a repetition of the set of multiple interlaced feedback data symbols during the second symbol period.

In some examples, the OCC component 945 may be configured as or otherwise support a means for applying a TD-OCC to the set of multiple interlaced feedback data symbols during the first symbol period and the repetition of the set of multiple interlaced feedback data symbols during the second symbol period.

In some examples, to support transmitting the feedback transmission, the feedback transmitter 935 may be configured as or otherwise support a means for transmitting, in accordance with the interlacing configuration, a first portion of the set of multiple interlaced feedback data symbols and a repetition of the first portion during the first symbol period, and a second portion of the set of multiple interlaced feedback data symbols and a repetition of the second portion during the second symbol period.

In some examples, the OCC component 945 may be configured as or otherwise support a means for applying a FD-OCC to the first portion of the set of multiple interlaced feedback data symbols and the repetition of the first portion during the first symbol period, and the second portion of the set of multiple interlaced feedback data symbols and the repetition of the second portion during the second symbol period.

In some examples, the set of multiple interlaced feedback data symbols are arranged according to a comb structure. In some examples, the set of multiple interlaced feedback data symbols are arranged according to a FDM scheme.

In some examples, to support transmitting the feedback transmission, the feedback transmitter 935 may be configured as or otherwise support a means for transmitting, in accordance with the interlacing configuration, a first portion of the set of multiple interlaced feedback data symbols during the first symbol period and a second portion of the set of multiple interlaced feedback data symbols during the second symbol period.

In some examples, to support transmitting the feedback transmission, the feedback transmitter 935 may be configured as or otherwise support a means for transmitting, in accordance with the interlacing configuration, the set of multiple interlaced feedback data symbols within a portion of the frequency range during the first symbol period and the second symbol period.

In some examples, the interlace component 950 may be configured as or otherwise support a means for receiving control signaling indicating the interlacing configuration. In some examples, the set of consecutive symbol periods includes two consecutive symbol periods or four consecutive symbol periods.

Additionally, or alternatively, the communications manager 920 may support wireless communication at a first UE in accordance with examples as disclosed herein. The sidelink resource component 940 may be configured as or otherwise support a means for receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group. In some examples, the sidelink receiver 925 may be configured as or otherwise support a means for receiving a sidelink transmission via a first set of sidelink resources of a slot of the subset of slots. In some examples, the feedback transmitter 935 may be configured as or otherwise support a means for transmitting a feedback transmission associated with the sidelink transmission via a first feedback resource of the feedback channel group or a second feedback resource of the feedback channel group.

In some examples, the control signaling includes a parameter that indicates a defined number of slots between a slot including a set of sidelink resources and the slot including the first feedback resource. In some examples, the first feedback resource occurs before the second feedback resource in time.

In some examples, the first feedback resource includes a reference PSFCH and the second feedback resource includes an additional PSFCH. In some examples, the sidelink resource component 940 may be configured as or otherwise support a means for receiving second control signaling indicating the feedback channel group.

In some examples, the sidelink resource component 940 may be configured as or otherwise support a means for receiving second control signaling activating a set of feedback resources of the feedback channel group.

Additionally, or alternatively, the communications manager 920 may support wireless communication at a first UE in accordance with examples as disclosed herein. In some examples, the sidelink resource component 940 may be configured as or otherwise support a means for receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period. In some examples, the sidelink receiver 925 may be configured as or otherwise support a means for receiving, from a second UE, a sidelink transmission via a set of resources of the first set of symbols. In some examples, the feedback transmitter 935 may be configured as or otherwise support a means for transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

In some examples, the sequence length corresponds to a number of resources elements in two or more resources blocks of the set of multiple RBs. In some examples, the sequence length component 955 may be configured as or otherwise support a means for receiving second control signaling indicating the sequence length of the interlace sequence.

In some examples, the sequence length component 955 may be configured as or otherwise support a means for updating the sequence length of the interlace sequence based on an environment characteristic associated with the first UE.

In some examples, the sidelink resource component 940 may be configured as or otherwise support a means for determining a resource pool for the PSSCH based on the sequence length.

In some cases, the sidelink receiver 925, the feedback transmitter 935, the OCC component 945, the sequence length component 955, the feedback generator component 930, the sidelink resource component 940, and the interlace component 950 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the sidelink receiver 925, the feedback transmitter 935, the OCC component 945, the sequence length component 955, the feedback generator component 930, the sidelink resource component 940, and the interlace component 950 discussed herein.

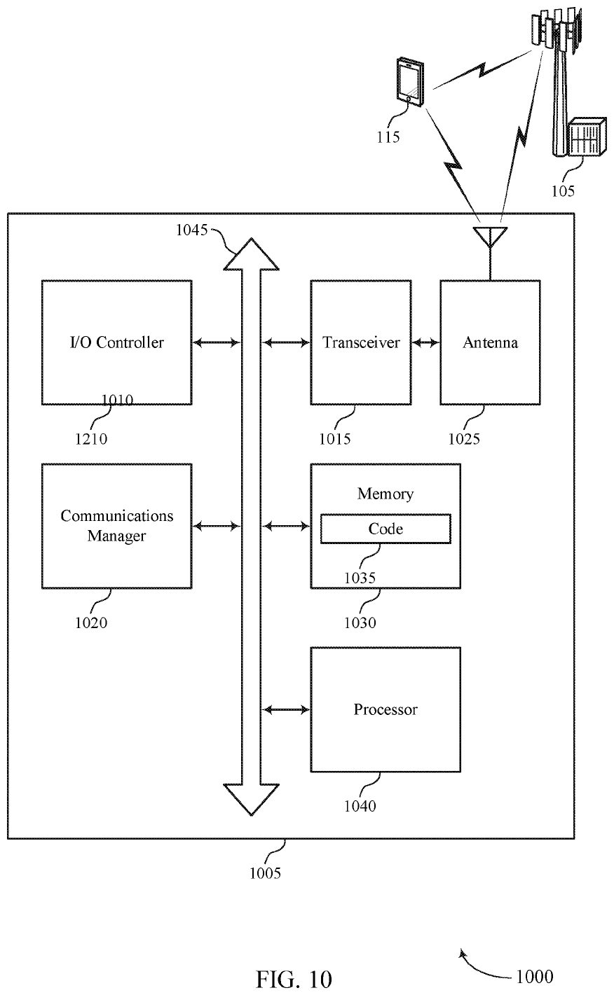

FIG. 10 shows a diagram of a system 1000 including a device 1005 that supports capacity enhancement for interlaced sidelink feedback transmissions in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOSR, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting capacity enhancement for interlaced sidelink feedback transmissions). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a first UE in accordance with examples as disclosed herein. For example, the communications manager 1020 may be configured as or otherwise support a means for receiving, from a second UE, sidelink signaling via a set of resources of a sidelink channel. The communications manager 1020 may be configured as or otherwise support a means for generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel. The communications manager 1020 may be configured as or otherwise support a means for transmitting, to the second UE within the frequency range via the first symbol period and the second symbol period, a feedback transmission based on the set of multiple interlaced feedback data symbols.

Additionally, or alternatively, the communications manager 1020 may support wireless communication at a first UE in accordance with examples as disclosed herein. For example, the communications manager 1020 may be configured as or otherwise support a means for receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group. The communications manager 1020 may be configured as or otherwise support a means for receiving a sidelink transmission via a first set of sidelink resources of a slot of the subset of slots. The communications manager 1020 may be configured as or otherwise support a means for transmitting a feedback transmission associated with the sidelink transmission via a first feedback resource of the feedback channel group or a second feedback resource of the feedback channel group.

Additionally, or alternatively, the communications manager 1020 may support wireless communication at a first UE in accordance with examples as disclosed herein. For example, the communications manager 1020 may be configured as or otherwise support a means for receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period. The communications manager 1020 may be configured as or otherwise support a means for receiving, from a second UE, a sidelink transmission via a set of resources of the first set of symbols. The communications manager 1020 may be configured as or otherwise support a means for transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB.

By including or configuring the communications manager 1020 in accordance with examples as described herein, the device 1005 may support techniques for improved communication reliability and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of capacity enhancement for interlaced sidelink feedback transmissions as described herein, or the processor 1040 and the memory 1030 may be otherwise configured to perform or support such operations.

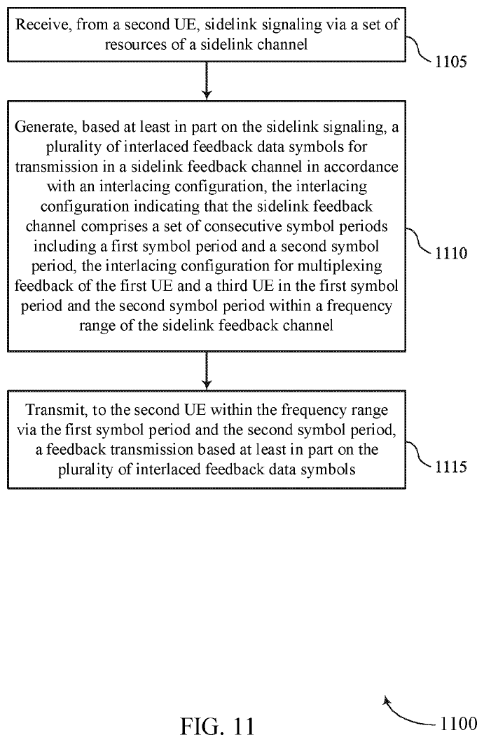

FIG. 11 shows a flowchart illustrating a method 1100 that supports capacity enhancement for interlaced sidelink feedback transmissions in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving, from a second UE, sidelink signaling via a set of resources of a sidelink channel. The operations of 1105 may be performed in accordance with examples as disclosed herein. In some examples, aspects of the operations of 1105 may be performed by a sidelink receiver 925 as described with reference to FIG. 9.

At 1110, the method may include generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel. The operations of 1110 may be performed in accordance with examples as disclosed herein. In some examples, aspects of the operations of 1110 may be performed by a feedback generator component 930 as described with reference to FIG. 9.

At 1115, the method may include transmitting, to the second UE within the frequency range via the first symbol period and the second symbol period, a feedback transmission based on the set of multiple interlaced feedback data symbols. The operations of 1115 may be performed in accordance with examples as disclosed herein. In some examples, aspects of the operations of 1115 may be performed by a feedback transmitter 935 as described with reference to FIG. 9.

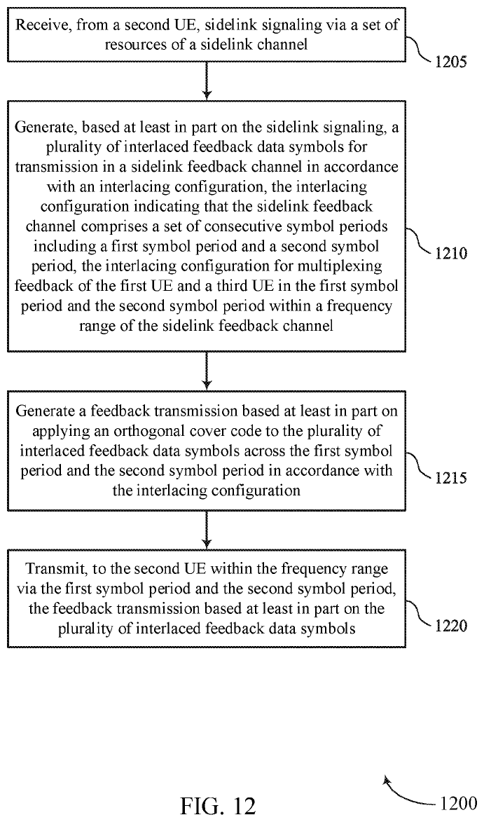

FIG. 12 shows a flowchart illustrating a method 1200 that supports capacity enhancement for interlaced sidelink feedback transmissions in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, from a second UE, sidelink signaling via a set of resources of a sidelink channel. The operations of 1205 may be performed in accordance with examples as disclosed herein. In some examples, aspects of the operations of 1205 may be performed by a sidelink receiver 925 as described with reference to FIG. 9.

At 1210, the method may include generating, based on the sidelink signaling, a set of multiple interlaced feedback data symbols for transmission in a sidelink feedback channel in accordance with an interlacing configuration, the interlacing configuration indicating that the sidelink feedback channel includes a set of consecutive symbol periods including a first symbol period and a second symbol period, the interlacing configuration for multiplexing feedback of the first UE and a third UE in the first symbol period and the second symbol period within a frequency range of the sidelink feedback channel. The operations of 1210 may be performed in accordance with examples as disclosed herein. In some examples, aspects of the operations of 1210 may be performed by a feedback generator component 930 as described with reference to FIG. 9.

At 1215, the method may include generating a feedback transmission based on applying an OCC to the set of multiple interlaced feedback data symbols across the first symbol period and the second symbol period in accordance with the interlacing configuration. The operations of 1215 may be performed in accordance with examples as disclosed herein. In some examples, aspects of the operations of 1215 may be performed by a feedback generator component 930 as described with reference to FIG. 9.

At 1220, the method may include transmitting, to the second UE within the frequency range via the first symbol period and the second symbol period, the feedback transmission based on the set of multiple interlaced feedback data symbols. The operations of 1220 may be performed in accordance with examples as disclosed herein. In some examples, aspects of the operations of 1220 may be performed by a feedback transmitter 935 as described with reference to FIG. 9.

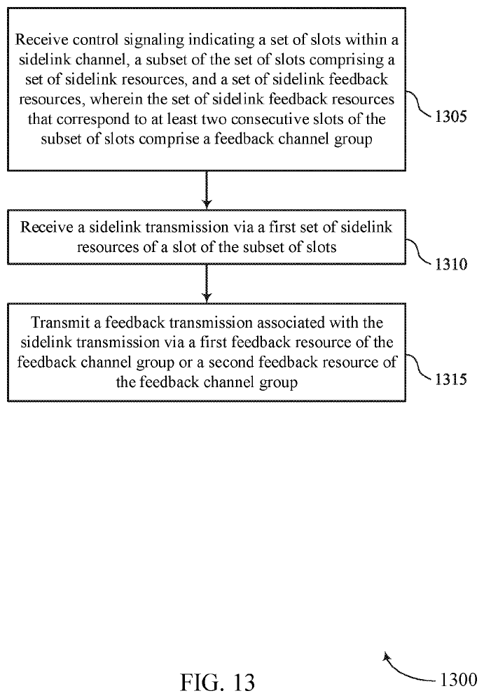

FIG. 13 shows a flowchart illustrating a method 1300 that supports capacity enhancement for interlaced sidelink feedback transmissions in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include a feedback channel group. The operations of 1305 may be performed in accordance with examples as disclosed herein. In some examples, aspects of the operations of 1305 may be performed by a sidelink resource component 940 as described with reference to FIG. 9.

At 1310, the method may include receiving a sidelink transmission via a first set of sidelink resources of a slot of the subset of slots. The operations of 1310 may be performed in accordance with examples as disclosed herein. In some examples, aspects of the operations of 1310 may be performed by a sidelink receiver 925 as described with reference to FIG. 9.

At 1315, the method may include transmitting a feedback transmission associated with the sidelink transmission via a first feedback resource of the feedback channel group or a second feedback resource of the feedback channel group. The operations of 1315 may be performed in accordance with examples as disclosed herein. In some examples, aspects of the operations of 1315 may be performed by a feedback transmitter 935 as described with reference to FIG. 9.

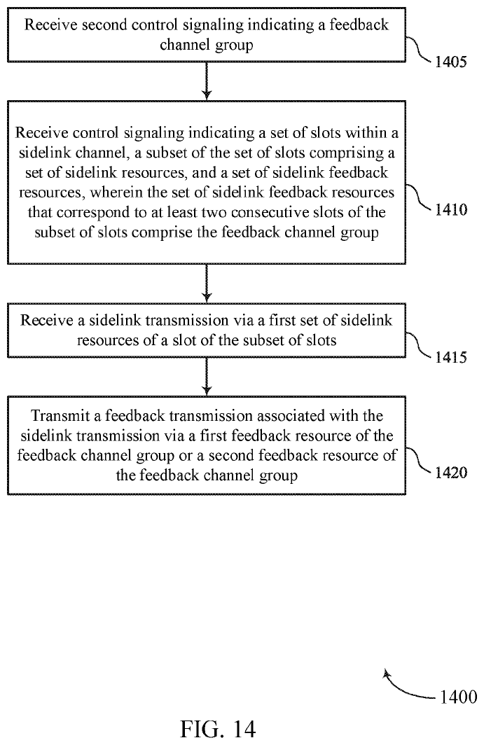

FIG. 14 shows a flowchart illustrating a method 1400 that supports capacity enhancement for interlaced sidelink feedback transmissions in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving second control signaling indicating a feedback channel group. The operations of 1405 may be performed in accordance with examples as disclosed herein. In some examples, aspects of the operations of 1405 may be performed by a sidelink resource component 940 as described with reference to FIG. 9.

At 1410, the method may include receiving control signaling indicating a set of slots within a sidelink channel, a subset of the set of slots including a set of sidelink resources, and a set of sidelink feedback resources, where the set of sidelink feedback resources that correspond to at least two consecutive slots of the subset of slots include the feedback channel group. The operations of 1410 may be performed in accordance with examples as disclosed herein. In some examples, aspects of the operations of 1410 may be performed by a sidelink resource component 940 as described with reference to FIG. 9.

At 1415, the method may include receiving a sidelink transmission via a first set of sidelink resources of a slot of the subset of slots. The operations of 1415 may be performed in accordance with examples as disclosed herein. In some examples, aspects of the operations of 1415 may be performed by a sidelink receiver 925 as described with reference to FIG. 9.

At 1420, the method may include transmitting a feedback transmission associated with the sidelink transmission via a first feedback resource of the feedback channel group or a second feedback resource of the feedback channel group. The operations of 1420 may be performed in accordance with examples as disclosed herein. In some examples, aspects of the operations of 1420 may be performed by a feedback transmitter 935 as described with reference to FIG. 9.

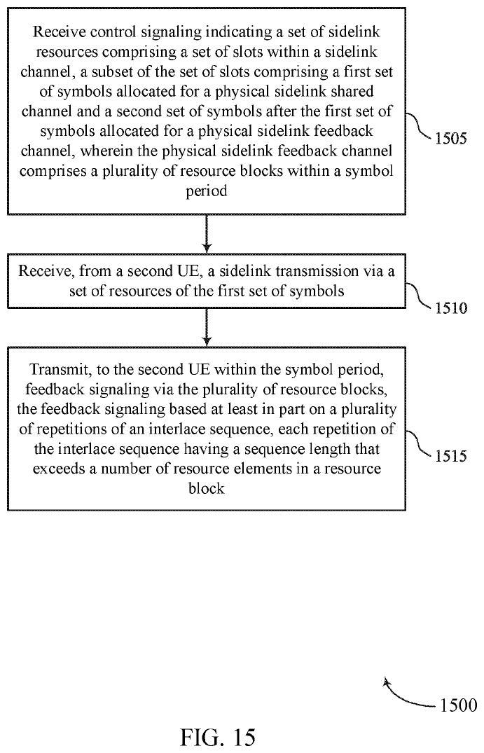

FIG. 15 shows a flowchart illustrating a method 1500 that supports capacity enhancement for interlaced sidelink feedback transmissions in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period. The operations of 1505 may be performed in accordance with examples as disclosed herein. In some examples, aspects of the operations of 1505 may be performed by a sidelink resource component 940 as described with reference to FIG. 9.

At 1510, the method may include receiving, from a second UE, a sidelink transmission via a set of resources of the first set of symbols. The operations of 1510 may be performed in accordance with examples as disclosed herein. In some examples, aspects of the operations of 1510 may be performed by a sidelink receiver 925 as described with reference to FIG. 9.

At 1515, the method may include transmitting, to the second UE within the symbol period, feedback signaling via the set of multiple RBs, the feedback signaling based on a set of multiple repetitions of an interlace sequence, each repetition of the interlace sequence having a sequence length that exceeds a number of REs in a RB. The operations of 1515 may be performed in accordance with examples as disclosed herein. In some examples, aspects of the operations of 1515 may be performed by a feedback transmitter 935 as described with reference to FIG. 9.

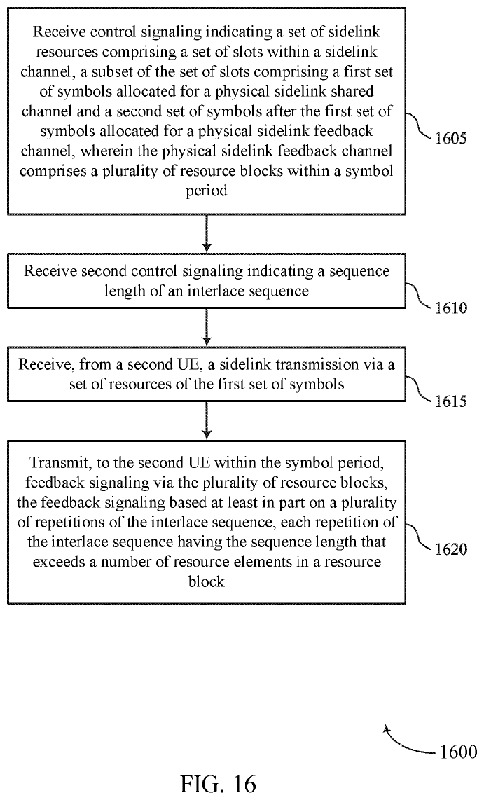

FIG. 16 shows a flowchart illustrating a method 1600 that supports capacity enhancement for interlaced sidelink feedback transmissions in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating a set of sidelink resources including a set of slots within a sidelink channel, a subset of the set of slots including a first set of symbols allocated for a PSSCH and a second set of symbols after the first set of symbols allocated for a PSFCH, where the PSFCH includes a set of multiple RBs within a symbol period. The operations of 1605 may be performed in accordance with examples as disclosed herein. In some examples, aspects of the operations of 1605 may be performed by a sidelink resource component 940 as described with reference to FIG. 9.

At 1610, the method may include receiving second control signaling indicating a sequence length of an interlace sequence. The operations of 1610 may be performed in accordance with examples as disclosed herein. In some examples, aspects of the operations of 1610 may be performed by a sequence length component 955 as described with reference to FIG. 9.

At 1615, the method may include receiving, from a second UE, a sidelink transmission via a set of resources of the first set of symbols. The operations of 1615 may be performed in accordance with examples as disclosed herein. In some examples, aspects of the operations of 1615 may be performed by a sidelink receiver 925 as described with reference to FIG. 9.

At 1620, the method may include transmitting, to the second UE within the symbol period, feedback signaling via the set of multiple RBs, the feedback signaling based on a set of multiple repetitions of the interlace sequence, each repetition of the interlace sequence having the sequence length that exceeds a number of REs in a RB. The operations of 1620 may be performed in accordance with examples as disclosed herein. In some examples, aspects of the operations of 1620 may be performed by a feedback transmitter 935 as described with reference to FIG. 9.

The following provides an overview of aspects of the present disclosure:

Aspect 1: A method for wireless communications at a first UE, comprising: receiving, from a second UE, sidelink signaling via a set of resources of a sidelink channel; generating, based at least in part on the sidelink signaling, a plurality of interlaced feedback data symbols for transmission in a sidelink feedback channel in accordance with an interlacing configuration, the interlacing configuration indicating that the sidelink feedback channel comprises a set of consecutive symbol periods including a first symbol period and a second symbol period, the interlacing configuration for multiplexing feedback of the first UE and a third UE in the first symbol period and the second symbol period within a frequency range of the sidelink feedback channel; and transmitting, to the second UE within the frequency range via the first symbol period and the second symbol period, a feedback transmission based at least in part on the plurality of interlaced feedback data symbols.

Aspect 2: The method of aspect 1, further comprising: generating the feedback transmission based at least in part on applying an OCC to the plurality of interlaced feedback data symbols across the first symbol period and the second symbol period in accordance with the interlacing configuration.

Aspect 3: The method of aspect 2, wherein the OCC comprises a TD-OCC or a FD-OCC.

Aspect 4: The method of any of aspects 1 through 3, further comprising: receiving control signaling indicating an OCC of a plurality of OCCs, the OCC assigned to the first UE.

Aspect 5: The method of any of aspects 1 through 4, further comprising: generating the plurality of interlaced feedback data symbols based at least in part on an interlace sequence indicated in the interlacing configuration.

Aspect 6: The method of any of aspects 1 through 5, wherein transmitting the feedback transmission comprises: transmitting, in accordance with the interlacing configuration, the plurality of interlaced feedback data symbols during the first symbol period and a repetition of the plurality of interlaced feedback data symbols during the second symbol period.

Aspect 7: The method of aspect 6, further comprising: applying a TD-OCC to the plurality of interlaced feedback data symbols during the first symbol period and the repetition of the plurality of interlaced feedback data symbols during the second symbol period.

Aspect 8: The method of any of aspects 1 through 5, wherein transmitting the feedback transmission comprises: transmitting, in accordance with the interlacing configuration, a first portion of the plurality of interlaced feedback data symbols and a repetition of the first portion during the first symbol period, and a second portion of the plurality of interlaced feedback data symbols and a repetition of the second portion during the second symbol period.

Aspect 9: The method of aspect 8, further comprising: applying a FD-OCC to the first portion of the plurality of interlaced feedback data symbols and the repetition of the first portion during the first symbol period, and the second portion of the plurality of interlaced feedback data symbols and the repetition of the second portion during the second symbol period.

Aspect 10: The method of any of aspects 1 through 5, wherein transmitting the feedback transmission comprises: transmitting, in accordance with the interlacing configuration, a first portion of the plurality of interlaced feedback data symbols during the first symbol period and a second portion of the plurality of interlaced feedback data symbols during the second symbol period.

Aspect 11: The method of aspect 10, wherein transmitting the feedback transmission comprises: transmitting, in accordance with the interlacing configuration, the plurality of interlaced feedback data symbols within a portion of the frequency range during the first symbol period and the second symbol period.

Aspect 12: The method of aspect 11, wherein the plurality of interlaced feedback data symbols are arranged according to a comb structure.

Aspect 13: The method of aspect 11, wherein the plurality of interlaced feedback data symbols are arranged according to a FDM scheme.

Aspect 14: The method of any of aspects 1 through 11, further comprising: receiving control signaling indicating the interlacing configuration.

Aspect 15: The method of any of aspects 1 through 14, wherein the set of consecutive symbol periods comprises two consecutive symbol periods or four consecutive symbol periods.

Aspect 16: A method for wireless communication at a first UE, comprising: receiving control signaling indicating a set of slots within a sidelink channel, a subset of the set of slots comprising a set of sidelink resources, and a set of sidelink feedback resources, wherein the set of sidelink feedback resources that correspond to at least two consecutive slots of the subset of slots comprise a feedback channel group; receiving a sidelink transmission via a first set of sidelink resources of a slot of the subset of slots; and transmitting a feedback transmission associated with the sidelink transmission via a first feedback resource of the feedback channel group or a second feedback resource of the feedback channel group.

Aspect 17: The method of aspect 16, wherein the control signaling comprises a parameter that indicates a defined number of slots between a slot comprising a set of sidelink resources and the slot comprising the first feedback resource.

Aspect 18: The method of any of aspects 16 through 17, wherein the first feedback resource occurs before the second feedback resource in time.

Aspect 19: The method of aspect 18, wherein the first feedback resource comprises a reference PSFCH and the second feedback resource comprises an additional PSFCH.

Aspect 20: The method of any of aspects 16 through 19, further comprising: receiving second control signaling indicating the feedback channel group.

Aspect 21: The method of any of aspects 16 through 20, further comprising: receiving second control signaling activating a set of feedback resources of the feedback channel group.

Aspect 22: A method for wireless communication at a first UE, the method comprising: receiving control signaling indicating a set of sidelink resources comprising a set of slots within a sidelink channel, a subset of the set of slots comprising a first set of symbols allocated for a PSSCH and a second set of symbols after the first set of symbols allocated for a PSFCH, wherein the PSFCH comprises a plurality of RBs within a symbol period; receiving, from a second UE, a sidelink transmission via a set of resources of the first set of symbols; and transmitting, to the second UE within the symbol period, feedback signaling via the plurality of RBs, the feedback signaling based at least in part on a plurality of repetitions of an interlace sequence, each repetition of the interlace sequence having a sequence length that exceeds a number of REs in a RB.

Aspect 23: The method of aspect 22, wherein the sequence length corresponds to a number of resources elements in two or more resources blocks of the plurality of RBs.

Aspect 24: The method of any of aspects 22 through 23, further comprising: receiving second control signaling indicating the sequence length of the interlace sequence.

Aspect 25: The method of any of aspects 22 through 24, further comprising: updating the sequence length of the interlace sequence based at least in part on an environment characteristic associated with the first UE.

Aspect 26: The method of any of aspects 22 through 25, further comprising: determining a resource pool for the PSSCH based at least in part on the sequence length.

Aspect 27: An apparatus for wireless communications at a first UE, comprising a processor; memory coupled with the processor; and instructions stored in the memory and executable by the processor to cause the apparatus to perform a method of any of aspects 1 through 15.

Aspect 28: An apparatus for wireless communications at a first UE, comprising at least one means for performing a method of any of aspects 1 through 15.

Aspect 29: A non-transitory computer-readable medium storing code for wireless communications at a first UE, the code comprising instructions executable by a processor to perform a method of any of aspects 1 through 15.

Aspect 30: An apparatus for wireless communication at a first UE, comprising a processor; memory coupled with the processor; and instructions stored in the memory and executable by the processor to cause the apparatus to perform a method of any of aspects 16 through 21.

Aspect 31: An apparatus for wireless communication at a first UE, comprising at least one means for performing a method of any of aspects 16 through 21.

Aspect 32: A non-transitory computer-readable medium storing code for wireless communication at a first UE, the code comprising instructions executable by a processor to perform a method of any of aspects 16 through 21.

Aspect 33: An apparatus for wireless communication at a first UE, comprising a processor; memory coupled with the processor; and instructions stored in the memory and executable by the processor to cause the apparatus to perform a method of any of aspects 22 through 26.

Aspect 34: An apparatus for wireless communication at a first UE, comprising at least one means for performing a method of any of aspects 22 through 26.

Aspect 35: A non-transitory computer-readable medium storing code for wireless communication at a first UE, the code comprising instructions executable by a processor to perform a method of any of aspects 22 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor;
memory coupled with the processor; and
instructions stored in the memory and executable by the processor to cause the apparatus to:
receive, from a second UE, sidelink signaling via a set of resources of a sidelink channel;
generate, based at least in part on the sidelink signaling, a plurality of interlaced feedback data symbols for transmission in a sidelink feedback channel in accordance with an interlacing configuration, the interlacing configuration indicating that the sidelink feedback channel comprises a set of consecutive symbol periods including a first symbol period and a second symbol period, the interlacing configuration for multiplexing feedback of the first UE and a third UE in the first symbol period and the second symbol period within a frequency range of the sidelink feedback channel; and
transmit, to the second UE within the frequency range via the first symbol period and the second symbol period, a feedback transmission based at least in part on the plurality of interlaced feedback data symbols.

2. The apparatus of claim 1, wherein the instructions are further executable by the processor to cause the apparatus to:
generate the feedback transmission based at least in part on applying an orthogonal cover code to the plurality of interlaced feedback data symbols across the first symbol period and the second symbol period in accordance with the interlacing configuration.

3. The apparatus of claim 2, wherein the orthogonal cover code comprises a time-domain orthogonal cover code or a frequency-domain orthogonal cover code.

4. The apparatus of claim 1, wherein the instructions are further executable by the processor to cause the apparatus to:
receive control signaling indicating an orthogonal cover code of a plurality of orthogonal cover codes, the orthogonal cover code assigned to the first UE.

5. The apparatus of claim 1, wherein the instructions are further executable by the processor to cause the apparatus to:
generate the plurality of interlaced feedback data symbols based at least in part on an interlace sequence indicated in the interlacing configuration.

6. The apparatus of claim 1, wherein the instructions are further executable by the processor to transmit the feedback transmission by being executable by the processor to:
transmit, in accordance with the interlacing configuration, the plurality of interlaced feedback data symbols during the first symbol period and a repetition of the plurality of interlaced feedback data symbols during the second symbol period.

7. The apparatus of claim 6, wherein the instructions are further executable by the processor to cause the apparatus to:
apply a time-domain orthogonal cover code to the plurality of interlaced feedback data symbols during the first symbol period and the repetition of the plurality of interlaced feedback data symbols during the second symbol period.

8. The apparatus of claim 1, wherein the instructions are further executable by the processor to transmit the feedback transmission by being executable by the processor to:
transmit, in accordance with the interlacing configuration, a first portion of the plurality of interlaced feedback data symbols and a repetition of the first portion during the first symbol period, and a second portion of the plurality of interlaced feedback data symbols and a repetition of the second portion during the second symbol period.

9. The apparatus of claim 8, wherein the instructions are further executable by the processor to cause the apparatus to:
apply a frequency-domain orthogonal cover code to the first portion of the plurality of interlaced feedback data symbols and the repetition of the first portion during the first symbol period, and the second portion of the plurality of interlaced feedback data symbols and the repetition of the second portion during the second symbol period.

10. The apparatus of claim 1, wherein the instructions are executable by the processor to transmit the feedback transmission by being executable by the processor to:
transmit, in accordance with the interlacing configuration, a first portion of the plurality of interlaced feedback data symbols during the first symbol period and a second portion of the plurality of interlaced feedback data symbols during the second symbol period.

11. The apparatus of claim 1, wherein the instructions are executable by the processor to transmit the feedback transmission by being executable by the processor to:
transmit, in accordance with the interlacing configuration, the plurality of interlaced feedback data symbols within a portion of the frequency range during the first symbol period and the second symbol period.

12. The apparatus of claim 11, wherein the plurality of interlaced feedback data symbols are arranged according to a comb structure.

13. The apparatus of claim 11, wherein the plurality of interlaced feedback data symbols are arranged according to a frequency domain multiplexing scheme.

14. The apparatus of claim 1, wherein the instructions are further executable by the processor to cause the apparatus to:
receive control signaling indicating the interlacing configuration.

15. The apparatus of claim 1, wherein the set of consecutive symbol periods comprises two consecutive symbol periods or four consecutive symbol periods.

16. An apparatus for wireless communication at a first user equipment (UE), comprising:
a processor;
memory coupled with the processor; and
instructions stored in the memory and executable by the processor to cause the apparatus to:
receive control signaling indicating a set of slots within a sidelink channel, a subset of the set of slots comprising a set of sidelink resources, and a set of sidelink feedback resources, wherein the set of sidelink feedback resources that correspond to at least two consecutive slots of the subset of slots comprise a feedback channel group;
receive a sidelink transmission via a first set of sidelink resources of a slot of the subset of slots; and
transmit a feedback transmission associated with the sidelink transmission via a first feedback resource of the feedback channel group or a second feedback resource of the feedback channel group.

17. The apparatus of claim 16, wherein the control signaling comprises a parameter that indicates a defined number of slots between a slot comprising a set of sidelink resources and the slot comprising the first feedback resource.

18. The apparatus of claim 16, wherein the first feedback resource occurs before the second feedback resource in time.

19. The apparatus of claim 18, wherein the first feedback resource comprises a reference physical sidelink feedback channel and the second feedback resource comprises an additional physical sidelink feedback channel.

20. The apparatus of claim 16, wherein the instructions are further executable by the processor to cause the apparatus to:
receive second control signaling indicating the feedback channel group.

21. The apparatus of claim 16, wherein the instructions are further executable by the processor to cause the apparatus to:
receive second control signaling activating a set of feedback resources of the feedback channel group.

22. An apparatus for wireless communication at a first user equipment (UE), comprising:
a processor;
memory coupled with the processor; and
instructions stored in the memory and executable by the processor to cause the apparatus to:
receive control signaling indicating a set of sidelink resources comprising a set of slots within a sidelink channel, a subset of the set of slots comprising a first set of symbols allocated for a physical sidelink shared channel and a second set of symbols after the first set of symbols allocated for a physical sidelink feedback channel, wherein the physical sidelink feedback channel comprises a plurality of resource blocks within a symbol period;
receive, from a second UE, a sidelink transmission via a set of resources of the first set of symbols; and
transmit, to the second UE within the symbol period, feedback signaling via the plurality of resource blocks, the feedback signaling based at least in part on a plurality of repetitions of an interlace sequence, each repetition of the interlace sequence having a sequence length that exceeds a number of resource elements in a resource block.

23. The apparatus of claim 22, wherein the sequence length corresponds to a number of resources elements in two or more resources blocks of the plurality of resource blocks.

24. The apparatus of claim 22, wherein the instructions are further executable by the processor to cause the apparatus to:
receive second control signaling indicating the sequence length of the interlace sequence.

25. The apparatus of claim 22, wherein the instructions are further executable by the processor to cause the apparatus to:
update the sequence length of the interlace sequence based at least in part on an environment characteristic associated with the first UE.

26. The apparatus of claim 22, wherein the instructions are further executable by the processor to cause the apparatus to:
determine a resource pool for the physical sidelink shared channel based at least in part on the sequence length.

27. A method for wireless communications at a first user equipment (UE), comprising:
receiving, from a second UE, sidelink signaling via a set of resources of a sidelink channel;
generating, based at least in part on the sidelink signaling, a plurality of interlaced feedback data symbols for transmission in a sidelink feedback channel in accordance with an interlacing configuration, the interlacing configuration indicating that the sidelink feedback channel comprises a set of consecutive symbol periods including a first symbol period and a second symbol period, the interlacing configuration for multiplexing feedback of the first UE and a third UE in the first symbol period and the second symbol period within a frequency range of the sidelink feedback channel; and
transmitting, to the second UE within the frequency range via the first symbol period and the second symbol period, a feedback transmission based at least in part on the plurality of interlaced feedback data symbols.

28. The method of claim 27, further comprising:
generating the feedback transmission based at least in part on applying an orthogonal cover code to the plurality of interlaced feedback data symbols across the first symbol period and the second symbol period in accordance with the interlacing configuration.

29. The method of claim 27, further comprising:
receiving control signaling indicating an orthogonal cover code of a plurality of orthogonal cover codes, the orthogonal cover code assigned to the first UE.

30. The method of claim 27, further comprising:
generating the plurality of interlaced feedback data symbols based at least in part on an interlace sequence indicated in the interlacing configuration.
